(19) United States
(12) Patent Application Publication
(10) Pub. No.: US 2012/0176455 A1
(43) Pub. Date: Jul. 12, 2012

(54) PRINTING METHOD USING INK JET RECORDING

(75) Inventors: Hitoshi Ohta, Shiojiri-shi (JP); Hidehiko Komatsu, Chino-shi (JP); Yoshimasa Tamura, Kashiwa-shi (JP)

(73) Assignee: SEIKO EPSON CORPORATION.

(21) Appl. No.: 13/053,737

(22) Filed: Mar. 22, 2011

(30) Foreign Application Priority Data
Mar. 23, 2010 (JP) 2010-066540

(51) Int. Cl. B41J 2/01

(52) U.S. Cl. 347/102

(57) ABSTRACT

Printing is performed on a non-ink absorbing or low-ink absorbing recording medium, by providing a drying process, using an aqueous ink composition at least containing glycol ethers having an HLB value calculated by the Davis method in the range of 4.2 to 8.0 and 1,2-alkyldiols having 4 to 8 carbon atoms and a liquid composition at least containing glycol ethers having an HLB value calculated by the Davis method in the range of 4.2 to 8.0 and 1,2-alkyldiols having 4 to 8 carbon atoms.

### BACKGROUND

1. Technical Field

The present invention relates to a printing method using ink jet recording.

2. Related Art

The printing method using ink jet recording is performed by letting small ink droplets fly and attaching the same onto a recording medium, such as paper. With recent innovative progress of an ink jet recording technique, printing methods using an ink jet recording method have been increasingly used also in the field of high resolution image recording (image printing) to which photograph or offset printing has been used heretofore. Therefore, high quality printed materials have been demanded for not only generally used regular paper or exclusive paper for ink jet recording (mat type or glossy type) but a non-ink absorbing or low-ink absorbing recording medium, such as printing paper, synthetic paper, or film.

Ink compositions with which high quality images can be obtained on regular paper, exclusive paper for ink jet recording, or the like have been variously proposed heretofore. Specifically, an ink composition at least containing pigments coated with water insoluble polymers, specific glycol ethers, and 1,2-alkyldiols have been proposed (Japanese Unexamined Patent Application Publication No. 2009-235155).

In recent years, an aqueous ink has been increasingly used from the viewpoint of safety and protecting the environment in place of a solvent pigment ink that has been used for a film recording medium, such as a polyvinyl chloride base material, i.e., a non-ink absorbing recording medium. Specifically, a method for performing printing, on a hydrophobic surface, using ink containing water, a glycol solvent, an insoluble colorant, a polymer dispersing agent, a silicone surfactant, a fluorinated surfactant, a water insoluble graft copolymer binder, and N-methylpyrrolidone as an example of such an aqueous ink has been proposed (Japanese Unexamined Patent Application Publication No. 2000-44858). Furthermore, an aqueous ink jet ink containing a polymer colloid to be used for printing on a non-porous base material containing an aqueous liquid vehicle containing a volatile co-solvent having a boiling point of 285° C. or lower, acid functionalized polymer colloidal particles, and a pigment colorant has been proposed (Japanese Unexamined Patent Application Publication No. 2005-220352).

However, the abrasion resistance of printed images formed on recording media with the aqueous inks that have been proposed heretofore is not sufficient, and thus a method for recording printed images having more excellent durability and abrasion resistance has been demanded.

For example, Japanese Unexamined Patent Application Publication No. 2004-195451 has proposed an aqueous liquid composition (overcoat composition) to be applied onto printed images for the purpose of imparting high resistance to images after printing. This composition is a composition containing an aqueous carrier, a moisturizer, a surfactant, and an addition polymer having an acid value exceeding 110. When the composition is applied onto printed images, the image surface is protected, thereby imparting high durability, in addition, Japanese Unexamined Patent Application Publication No. 2000-44858 described above has proposed a printing method having a process for applying an overcoat composition excluding a colorant from an ink composition.

However, since the non-ink absorbing and low-ink absorbing recording media have no ink absorption layer, ink or an overcoat composition does not permeate into the recording media, so that the ink or the overcoat composition does not sufficiently attach to the surface of the recording media. Therefore, even when the overcoat composition is applied to the printed image surface, a problem of separation particularly at the interface of the recording medium and the printed image has occurred. Even when ink for forming a printed image transfers to a contact substance to pollute the contact substance, the information to be passed by the printed image can be passed when at least the information of the printed image is not lost. However, when the printed image separates from the recording medium due to contacting or the like, so that the information of the printed image is lost, the information to be passed by the printed image cannot be passed, which sometimes results in a serious accident depending on the lost contents.

With the aqueous inks or the printing methods using the same that have been proposed heretofore, the printing quality of images formed on a non-ink absorbing or low-ink absorbing recording medium is not sufficiently excellent, and thus an ink composition in which the properties have been further improved and a printing method using the same have been demanded. Specifically, a phenomenon of mixing of different color inks or ink spreading beyond a desired region (hereinafter referred to as “bleeding”) arises or a phenomenon in which spots are formed at high ink concentration portions and low ink concentration portions (hereinafter referred to as “concentration unevenness”) in a solid image arises, and thus a desired printing quality has not been obtained with the former ink compositions and the former printing methods using the same.

### SUMMARY

An advantage of some aspects of the invention is to provide a printed image having excellent abrasion resistance and having suppressed bleeding or concentration unevenness to a non-ink absorbing or low-ink absorbing recording medium and also provide a printing method using ink jet recording in which the storage stability is secured and stable ejection from an ink jet head can be achieved.

A printing method using ink jet recording according to a first aspect of the invention is a printing method for forming an image on a non-ink absorbing or low-ink absorbing recording medium using an ink jet recording method, and the method includes:
(1) a first printing process for performing printing with an aqueous ink composition containing a colorant on a recording medium;
(2) a second printing process for printing an aqueous liquid composition that does not contain a colorant and at least contains polymer particles in such a manner as to cover the printed image printed with the aqueous ink composition; and
(3) a drying process for drying the printed image printed on the recording medium at a timing of at least any one of during the first printing process, after the first printing process, during the second printing process, and after the second printing process, in which
(4) the aqueous ink composition at least contains a water insoluble colorant, glycol ethers having an HLB value calculated by the Davis method in the range of 4.2 to 8.0, 1,2-alkyldiols having 4 to 8 carbon atoms, and water; and
(5) the aqueous liquid composition at least contains glycol ethers having an HLB value calculated by the Davis method in the range of 4.2 to 8.0, 1,2-alkyldiols having 4 to 8 carbon atoms, polymer particles, wax particles, and water.

In the printing method using ink jet recording according to the first aspect of the invention, an alkyl group of the glycol ethers have a branched structure in each of the aqueous ink composition and the aqueous liquid composition.

In the printing method using ink jet recording of the invention according to the aspects of the invention, the glycol ethers contained in the aqueous ink composition are contained in the range of 0.1% by mass to 6% by mass based on the total amount of the aqueous ink composition and the glycol ethers contained in the aqueous liquid composition are contained in the range of 0.1% by mass to 6% by mass based on the total amount of the aqueous liquid composition.

In the printing method using ink jet recording according to any one of the aspects of the invention, the 1,2-alkyldiols are contained 0.5 time to 5 times the glycol ethers in terms of mass ratio in each of the aqueous ink composition and the aqueous liquid composition.

In the printing method using ink jet recording according to any one of the aspects of the invention, the alkyl group of the glycol ethers is a 2-ethylhexyl group in each of the aqueous ink composition and the aqueous liquid composition.

In the printing method using ink et recording according to any one of the aspects of the invention, the 1,2-alkyldiols contained in the aqueous ink composition are contained in the range of 0.5% by mass to 20% by mass based on the total amount of the aqueous ink composition and the 1,2-alkyldiols contained in the aqueous liquid composition are contained in the range of 0.5% by mass to 20% by mass based on the total amount of the aqueous liquid composition.

In the printing method using ink jet recording according to any one of the aspects of the invention, the aqueous ink composition and the liquid composition further contain a pyrrolidone derivative.

In the printing method using ink jet recording according to any one of the aspects of the invention, the aqueous ink composition and the liquid composition further contain a pyrrolidone resin derivative.

In the printing method using ink jet recording according to any one of the aspects of the invention, the aqueous ink composition further contains polymer particles.

In the printing method using ink jet recording according to any one of the aspects of the invention, the drying process is a drying process including heat treatment and the heating temperature after printing is higher than the heating temperature during printing in each of the first printing process and the second printing process.

### DESCRIPTION OF EXEMPLARY EMBODIMENTS

Hereinafter, embodiments suitable for the invention will be described in detail.

### 1. Printing Method Using Ink Jet Recording

A printing method using ink jet recording according to this embodiment is a printing method for forming an image on a non-ink absorbing or low-ink absorbing recording medium using an ink jet recording method, and the method includes:
(1) a first printing process for performing printing with an aqueous ink composition containing a colorant on a recording medium;
(2) a second printing process for printing an aqueous liquid composition that does not contain a colorant and at least contains polymer particles in such a manner as to cover the printed image printed with the aqueous ink composition; and
(3) a drying process for drying the printed image printed on the recording medium at a timing of at least any one of during the first printing process, after the first printing process, during the second printing process, and after the second printing process, in which
(4) the aqueous ink composition at least contains a water insoluble colorant, glycol ethers having an HLB value calculated by the Davis method in the range of 4.2 to 8.0, 1,2-alkyldiols having 4 to 8 carbon atoms, and water; and
(5) the aqueous liquid composition at least contains glycol ethers having an HLB value calculated by the Davis method in the range of 4.2 to 8.0, 1,2-alkyldiols having 4 to 8 carbon atoms, polymer particles, wax particles, and water.

In the printing method using ink jet recording of the invention (hereinafter also referred to as a printing method), an aqueous liquid composition as a overcoat liquid is printed on the printed image surface in the second printing process in order to impart abrasion resistance to the printed image recorded on a non-ink absorbing or low-ink absorbing recording medium with the aqueous ink composition in the first printing process. Since the aqueous liquid composition according to an embodiment of the invention has excellent wettability to the non-ink absorbing or low-ink absorbing recording medium and also has excellent drying properties due to the formation, unevenness or hazing does not arise on the recording medium surface after drying, and thus an overcoat layer (hereinafter also referred to as a coat layer) excellent in abrasion resistance can be formed. Therefore, a phenomenon of separation at the interface surface between the recording medium and the recorded image formed on the recording medium is also suppressed. Since the aqueous liquid composition according to an embodiment of the invention has excellent wettability to a non-ink absorbing or low-ink absorbing recording medium and also has excellent drying properties due to the formation, printed images having suppressed bleeding or concentration unevenness can be formed.

First, the aqueous ink composition and the aqueous liquid composition to be used in the printing method using ink jet recording according to this embodiment will be described below.

### 1.1 Aqueous Ink Composition and Aqueous Liquid Composition

The aqueous ink composition for use in the printing method using ink jet recording according to an embodiment of the invention at least contains a water insoluble colorant, glycol ethers having an HLB value calculated by the Davis method in the range of 4.2 to 8.0, 1,2-alkyldiols having 4 to 8 carbon atoms, and water. Similarly, the aqueous liquid composition does not contain a colorant and at least contains glycol ethers having an HLB value calculated by the Davis method in the range of 4.2 to 8.0, 1,2-alkyldiols having 4 to 8 carbon atoms, polymer particles, wax, particles, and water. The constituent materials thereof will be described in detail below.

### 1.1.1 Colorant

As the colorant of the aqueous ink composition for use in the printing method according to an embodiment of the invention, dyes or pigments can all be used. When used for printing on a non-ink absorbing or low-ink absorbing medium, water insoluble disperse dyes or pigments are more preferable from the viewpoint of durability, such as water resistance and abrasion resistance, of printed materials.

As dyes usable as the colorant, various dyes that are usually used for an ink jet recording method, such as direct dyes, acid dyes, edible dyes, basic dyes, reactive dyes, disperse dyes, vat dyes, soluble vat dyes, and reactive disperse dyes, can be used, and water insoluble disperse dyes are preferable in terms of durability as described above. Mentioned as preferable disperse dyes are, for example, C.I. disperse black 1, 2, 3, 4, 5, 6, 7, 8, 9, 10, 11, 12, 14, 15, 20, 22, 24, 25, 26, 27, 28, 29, 30, 31, 32, 33, 34, and 39; C.I. disperse yellow 5, 42, 54, 64, 79, 82, 83, 93, 99, 100, 119, 122, 124, 126, 160, 184:1, 186, 198, 199, 204, 211, 224, and 237; C.I. disperse orange 8, 13, 29, 31:1, 33, 49, 54, 55, 66, 73, 118, 119, and 163; C.I. disperse red 54, 60, 72, 73, 86, 88, 91, 92, 93, 111, 126, 127, 134, 135, 143, 145, 152, 153, 154, 159, 164, 167:1, 177, 179, 181, 204, 206, 207, 221, 239, 240, 258, 277, 278, 283, 298, 311, 323, 343, 348, 356, and 362; C.I. disperse violet 26, 33, and 77; C.I. disperse blue 56, 60, 73, 79, 79:1, 87, 87:1, 113, 128, 143, 149, 154, 158, 165, 165:1, 165;2, 176, 183, 185, 197, 198, 201, 214, 224, 225, 257, 266, 267, 287, 354, 353, 365, and 368; and C.I. disperse green 6:1 and 9. The content of the disperse dye mentioned above in the aqueous ink composition is about 0.5% by mass to about 20% by mass and preferably about 1% by mass to about 10% by mass based on the total amount of the aqueous ink composition.

As pigments, known inorganic pigments, organic pigments, and carbon black can all be used. Among the above, carbon black and organic pigments are preferable from the viewpoint that the color development is good and the precipitation during dispersion is hard to occur due to a specific low gravity.

In the invention, mentioned as specific preferable examples of carbon black are furnace black, lamp black, acetylene black, channel black, and the like (C.I. Pigment black 7). Mentioned as commercially available items are No. 2300, 900, MCF88, No. 20B, No. 33, No. 40, No. 45, No. 52, MA7, MA8, MA100, No. 2200B, and the like (all trade names, manufactured by Mitsubishi Chemical, Inc.), color black FW1, FW2, FW2V, FW18, FW200, S150, S160, S170, Pritex 35, U, V, 140U, Special Black 6, 5, 4A, 4, and 250, and the like (all trade names, manufactured by Degussa), Conductex SC, Raven 1255, 5750, 5250, 5000, 3500, 1255, and 700, and the like (all trade names, manufactured by Columbia Carbon Co., Ltd.), Regal 400R, 330R, and 660R, Mogul L, Monarch 700, 800, 880, 900, 1000, 1100, 1300, and 1400, Elftex 12, and the like (all trade names, manufactured by Cabot Corp.). The substances are mentioned as an example of carbon black suitable for the invention and the invention is not limited by the substances. These carbon blacks may be used singly or as a mixture of two or more kinds thereof. The content of these carbon blacks is 0.5% by mass to 20% by mass and preferably 1% by mass to 10% by mass based on the total amount of the black ink composition.

Mentioned as preferable organic pigments in the invention are quinacridone pigments, quinacridone quinone pigments, dioxazine pigments, phthalocyanine pigments, anthrapyrimidine pigments, anthanthrone pigments, indanthrone pigments, flavanthrone pigments, perylene pigments, diketooyrrolopyrrole pigments, perynone pigments, quinophthalone pigments, anthraquinone pigments, thioindigo pigments, benzimidazolone pigments, isoindolinone pigments, azomethine pigments, azo pigments, and the like.

The following substances are mentioned as specific examples of the organic pigments for use in the aqueous ink composition according to an embodiment the invention.

Mentioned as pigments for use in a cyan ink composition are C.I. Pigment Blue 1, 2, 3, 15:3, 15:4, 15:34, 16, 22, and 60, C.I. Vat Blue 4 and 60, and the like. Preferable are a single pigment or a mixture of two or more pigments selected from the group consisting of C.I. Pigment Blue 15:3, 15:4, and 60. The content of these pigments is about 0.5% by mass to about 20% by mass and preferably about 1% by mass to 10% by masses based on the total amount of the cyan ink composition.

Mentioned as pigments for use in a magenta ink composition are C.I. Pigment Red 5, 7, 12, 48(Ca), 48(Mn), 57(Ca), 57:1, 112, 122, 123, 168, 184, 202, and 209, C.I. Pigment Violet 19, and the like. Preferable are a single pigment or a mixture of two or more pigments selected from the group consisting of C.I. Pigment Red 122, 202, and 209 and C.I. Pigment Violet 19. The content of these pigments is about 0.5% by mass to 20% by mass and preferably about 1% by mass to about 10% by mass based on the total amount of the magenta ink composition.

Mentioned as pigments for use in a yellow ink composition are C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, and 185 and the like. Preferable are a single pigment or a mixture of two or more pigments selected from the group consisting of C.I. Pigment Yellow 74, 109, 110, 128, and 138. The content of these pigments is about 0.5% by mass to about 20% by mass and preferably about 1% by mass to about 10% by mass based on the total amount of the yellow ink composition.

Mentioned as pigments for use in an orange ink composition are C.I. Pigment orange 36 or 43 or a mixture thereof. The content of these pigments is about 0.5% by mass to about 20% by mass preferably about 1% by mass to 10% by mass based on the total amount of the orange ink composition.

Mentioned as pigments for use in a green ink composite on are C.I. Pigment green 7 or 36 or a mixture thereof. The content of these pigments is about 0.5% by mass to about 20% by mass and preferably about 1% by mass to about 10% by mass based on the total amount of the green ink composition.

In order to apply the disperse dyes and pigments to the aqueous ink composition, the disperse dyes and the pigments need to be able to be stably dispersed and held in water. Examples of methods therefor include a dispersing method using a resin dispersing agent, such as water-soluble resin and/or water dispersible resin (hereinafter pigments treated with the method are referred to as “resin dispersed pigments”), a dispersing method using a surfactant, such as a water-soluble surfactant and/or a water dispersible surfactant (hereinafter pigments treated with the method are referred to as “surfactant dispersed pigments”), and a method for rendering the pigments dispersible and/or soluble in water by chemically and/or physically introducing a hydrophilic functional group into the surface of pigment particles without the use of the dispersing agents, such as the resin dispersing agent or the surfactant (hereinafter pigments treated with the method are referred to as “surface treated pigments”). The aqueous ink composition for use in the printing method according to this embodiment can employ any of the disperse dyes, the resin dispersed pigments, the surfactant dispersed pigments, and the surface treated pigments and two or more thereof can be mixed as required.

Mentioned as the resin dispersing agents for use in the resin dispersed pigments are polyvinyl alcohols, polyacrylic acid, an acrylic acid-acrylonitrile copolymer, a vinyl acetate-acrylic acid ester copolymer, an acrylic acid-acrylic acid ester copolymer, a styrene-acrylic acid copolymer, a styrene-methacrylic acid copolymer, a styrene-methacrylic acid-acrylic acid ester copolymer, a styrene-α-methyl styrene-acrylic acid copolymer, a styrene-α-methyl styrene-acrylic acid-acrylic acid ester copolymer, a styrene-maleic acid copolymer, a styrene-maleic anhydride copolymer, a vinyl naphthalene-acrylic acid copolymer, a vinyl naphthalene-maleic acid copolymer, a vinyl acetate-maleic acid ester copolymer, a vinyl acetate-protonic acid copolymer, and a vinyl acetate-acrylic acid copolymer and a salt thereof. Among the above, a copolymer of a monomer having a hydrophobic functional group and a monomer having a hydrophilic functional group and a polymer containing monomers having a hydrophobic functional group and a hydrophilic functional group are preferable. As the form of the copolymer, any form of a random copolymer, a block copolymer, an alternating copolymer, and a graft copolymer can be used.

Mentioned as the salts are salts with basic compounds, such as ammonia, ethylamine, diethylamine, triethylamine, propylamine, isopropylamine, dipropylamine, butylamine, isobutylamine, diethanolamine, triethanolamine, triisopropanolamine, aminomethyloropanol, and morpholine. The addition amount of these basic compounds is not particularly limited insofar as the amount is equal to or more than the neutralization equivalent of the resin dispersing agents.

The molecular weight of the resin dispersing agents is preferably in the range of 1,000 to 100,000 and more preferably in the range of 3,000 to 10,000 as the weight average molecular weight. Based on the fact that the molecular weight is in the range above, stable dispersion of the colorant in water is achieved and the viscosity control or the like when applied to the aqueous ink composition is easily performed.

The acid value is preferably in the range of 50 to 300 and more preferably in the range of 70 to 150. When the acid value is in this range, the dispersibility of colorant particles in water can be stably secured and the water resistance of a printed material printed with the aqueous ink composition using the same is favorable.

Commercially available items can also be used as the resin dispersing agents described above. In detail, mentioned are JONCRYL 67 (Weight average molecular weight: 12,500, Acid value: 213), JONCRYL 678 (Weight average molecular weight: 8,500, Acid value: 215), JONCRYL 586 (Weight average molecular weight: 4,600, Acid value: 108), JONCRYL 611 (Weight average molecular weight: 8,100, Acid value: 53), JONCRYL 680 (Weight average molecular weight: 4,900, Acid value: 215), JONCRYL 682 (Weight average molecular weight: 1,700, Acid value: 238), JONCRYL 683 (Weight average molecular weight: 8,000, Acid value: 160), JONCRYL 690 (Weight average molecular weight: 16,500, Acid value: 240) (all trade names, manufactured by Basf Japan, Inc.), and the like.

Mentioned as the surfactant for use in the surfactant dispersed pigments are anionic surfactants, such as alkane sulfonate salts, α-olefin sulfonate salts, alkylbenzene sulfonate salts, alkylnaphthalene sulfonate salts, acylmethyl taurate salts, dialkyl sulfosuccinate salts, alkyl sulfate ester salts, olefin sulfates, polyoxyethylene alkyl ether sulfate ester salts, alkyl phosphate ester salts, polyoxyethylene alkyl ether phosphate ester salts, or monoglycerite phosphate ester salts, amphoteric surfactants, such as alkyl pyrdium salts, alkylamino acid salts, or alkyldimethyl betaines, and nonionic surfactants, such as polyoxyethylene alkyl ethers, polyoxyethylene alkylphenyl ethers, polyoxyethylene alkyl esters, polyoxyethylene alkylamides, glycerol alkyl esters, or sorbitan alkyl esters.

The addition amount of the resin dispersing agents or the surfactants mentioned above relative to the pigments is preferably 1 part by mass to 100 pars by mass and more preferably 5 parts by mass to 50 parts by mass based on 100 parts by mass of the pigments. Based on the fact that the addition amount thereof is in the range above, the dispersion stability of the pigments in water can be secured.

In the surface treated pigments, mentioned as the hydrophilic functional group are —OM, —COOM, —CO—, —SO3M, —SC2NH2, —RSO2M, —PO3HM, —PO3M2, —SO2NHCOR, —NH3, —NR3 (in Formulae, M represents a hydrogen atom, an alkali metal, ammonium, or organic ammonium, R represents: an alkyl group having 1 to 12 carbon atoms, a phenyl group that may have a substituent, or a naphthyl group that may have a substituent.), and the like. These functional groups are physically and/or chemically introduced into the surface of pigment particles by grafting thereon directly and/or through a polyvalent group. Examples of the polyvalent group include alkylene groups having 1 to 12 carbon atoms, a phenylene group that may have a substituent, and a naphthylene group that may have a substituent.

The surface treated pigments are preferably pigments that are surface treated in such a manner that SO3M and/or —RSO2M (M is a counter ion and represents a hydrogen ion, an alkali metal ion, an ammonium ion, or an organic ammonium ion) are/is chemically bonded to the surface of the pigment particles with a treating agent containing sulfur, i.e., the pigments are preferably pigments that are rendered dispersible and/or soluble in water by dispersing the pigments in a solvent which has no active protons and has no reactivity with sulfonic acid and in which the pigments are insoluble or difficult to dissolve, and then surface treating the same so that SO3M and/or —RSO2 M are/is chemically bonded to the surface of the particles by amidosulfuric acid or a complex of sulfur trioxide and tertiary amine.

As a surface treating measure for grafting the functional group or a salt: thereof on the surface of the pigment particles directly or through a polyvalent group, various known surface treating measures are applicable. Examples include a measure including acting ozone or a sodium hypochlorite solution on a commercially available carbon black oxide, and further oxidizing the carbon black for further hydrophilizing the surface (e.g., Japanese Unexamined Patent Application Publication Nos. 7-258578, 8-3498, 10-120958, 10-195331, and 10-237349), a measure for treating carbon black with 3-amino-N-alkyl-substituted Pyridium bromide (e.g., Japanese Unexamined Patent Application Publication Nos. 10-195360 and 10-330665), a measure including dispersing an organic pigment in a solvent in which the organic pigment is insoluble or difficult to dissolve, and introducing a sulfone group into the surface of pigment particles by a sulfonating agent (e.g., Japanese Unexamined. Patent Application Publication Nos. 6-283596, 10-110110, and 10-110111), and a measure for dispersing an organic pigment in a basic solvent forming a complex with sulfur trioxide, and surface treating the surface of the organic pigment by adding sulfur trioxide for introducing a sulfone group or a sulfone amino group (e.g., Japanese Unexamined Patent Application Publication No. 10-110114). The measures for producing the surface treated pigments for use in the invention are not limited to these measures.

A single functional group or a plurality of functional groups may be grafted on one carbon black particle. The type and the grafting degree of the functional group to be drafted may be determined as appropriate considering dispersion stability in ink, color density, and drying properties on the front surface of an ink jet head.

Methods for dispersing the resin dispersed pigments, the surfactant dispersed pigments, and the surface treated pigments described above in water can be carried out by adding, for the resin dispersed pigments, a pigment, water, and a resin dispersing agent, adding, for the surfactant dispersed pigments, a pigment, water, and a surfactant, and, for the surface treated pigments, adding the surface treated pigment and water, and, as required, adding a water soluble organic solvent, a neutralizer, and the like, to each thereof in a disperser used in former cases, such as a ball mill, a sand mill, an attritor, a roll mill, an agitator mill, a Henschel mixer, a colloid mill, an ultrasonic homogenizer, a jet mill, or an Ong Mill. In this case, it is preferable to disperse the pigment until the particle diameter of the pigment reaches the range of 20 nm to 500 nm and more preferably 50 nm to 200 nm in terms of average particle diameter from the viewpoint of securing dispersion stability of the pigment in water.

### 1.1.2 Glycol Ethers

The aqueous ink composition and the aqueous liquid composition for use in the invention contain glycol ethers having an HLB value calculated by the Davis method in the range of 4.2 to 8.0. By blending glycol ethers satisfying the HLB value range mentioned above in the aqueous ink composition and the aqueous liquid composition, the wettability and the penetration rate can be controlled without being hardly affected by a recording medium type, and, in the case of the aqueous ink composition, clear printed images with less concentration unevenness, high color development, and less bleeding can be obtained and, in the case of the aqueous liquid composition, a rigid overcoat layer (coat layer) can be uniformly formed on the printed image, and thus an image having excellent abrasion resistance can he obtained, on various recording media. Since, by a combination with 1,2-alkyldiols (1,2-alkyldiols having 4 to 8 carbon atoms) having compatibility with glycol ethers described later, the affinity with water which is the main solvent increases and the dispersibility of the disperse dyes, the resin dispersed pigments, the surfactant dispersed pigments, and the surface treated pigments described above is not adversely affected, the storage stability of the aqueous ink composition and the aqueous liquid composition is favorable and the ejection stability of liquid small droplets by an ink jet recording method is excellent.

Here, the HLB value of the glycol ethers used in the invention is a value for evaluating the hydrophilicity of compounds advocated by Davis et al., and is a numerical value determined by the Davis method defined in, for example, a literature of “J. T. Davies and E. K. Rideal, “Interface Phenomena” 2nd ed. Academic Press, New York 1963.” and refers to a value calculated by Formula (1).

HLB value=7+Σ[1]+Σ[2] Formula (1)

(In Formula (1), [1] represents the base of a hydrophilic group and [2] represents the base of a hydrophobic croup).

The base of typical hydrophilic groups and hydrophobic groups is shown in Table 1.

TABLE 1

| Structure | Base |
|---|---|
| —CH₂— | −0.475 |
| —CH₃ | −0.475 |
| —(CH₂CH₂O)— | +0.330 |
| 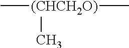 | −0.150 |
| —OH | +1.900 |

The aqueous ink composition and the aqueous liquid composition according to an embodiment of the invention contain glycol ethers having an HLB value calculated by the Davis method in the range of 4.2 to 8.0 as an essential component. The HLB value is preferably in the range of 4.2 to 8.0 and more preferably in the range of 4.2 to 7.1. When the HLB value is lower than 4.2, the hydrophobicity of glycol ethers increases to reduce the affinity with water which is the main solvent, which sometimes results in deterioration of the storage stability of the aqueous ink composition and the aqueous liquid composition. When the HLB value becomes larger than 8.0, the effects of the wettability and the permeability of the aqueous ink composition and the aqueous liquid composition to the recording medium decrease, which sometimes results in the fact that influences that concentration unevenness and bleeding are noticeable in printed images, the color development is poor, and the like are observed in the aqueous ink composition and influences that an overcoat layer formed with the aqueous liquid composition is not uniform, the abrasion resistance of the obtained printed images is poor, and the like are observed in the aqueous liquid composition. Mentioned as specific examples of the glycol ethers are ethylene glycol monoisobutyl ether, ethylene glycol monohexyl ether, ethylene glycol monoisohexyl ether, diethylene glycol monohexyl ether, triethylene glycol monohexyl ether, diethylene glycol monoisohexyl ether, triethylene glycol monoisohexyl ether, ethylene glycol monoisoheptyl ether, diethylene glycol monoisoheptyl ether, triethylene glycol monoisoheptyl ether, ethylene glycol monooctyl ether, ethylene glycol monoisooctyl ether, diethylene glycol monoisooctyl ether, triethylene glycol monoisooctyl ether, ethylene glycol mono-2-ethylhexyl ether, diethylene glycol mono-2-ethylhexyl ether, triethylene glycol mono-2-ethylhexyl ether, diethylene glycol mono-2-ethyl pentyl ether, ethylene glycol mono-2-ethyl pentyl ether, ethylene glycol mono-2-methyl pentyl ether, diethylene glycol mono-2-methyl pentyl ether, propylene glycol monobutyl ether, dipropylene glycol monobutyl ether, tripropylene glycol monobutyl ether, propylene glycol monopropyl ether, dipropylene glycol monopropyl ether, tripropylene glycol monomethyl ether, and the like. These substances can be used singly or as a mixture of two or more kinds thereof.

The aqueous ink composition and the aqueous liquid composition according to an embodiment of the invention preferably have a branched structure in the alkyl group of the glycol ethers. Based on the fact that the aqueous ink composition and the aqueous liquid composition contain the glycol ethers having a branched structure in the alkyl group, excellent printed images with less concentration unevenness, less bleeding, and high color development can be obtained in the case of the aqueous ink composition and, in the case of the aqueous liquid composition, a rigid overcoat layer can be uniformly formed on the printed image, and thus the abrasion resistance of the printed images is excellent on various recording media, irrespective of the recording medium type. Specific examples include ethylene glycol monoisobutyl ether, ethylene glycol monoisohexyl ether, diethylene glycol monoisohexyl ether, triethylene glycol monoisohexyl ether, ethylene glycol monoisoheptyl ether, diethylene glycol monoisoheptyl ether, triethylene glycol monoisoheptyl ether, ethylene glycol monoisooctyl ether, diethylene glycol monoisooctyl ether, triethylene glycol monoisooctyl ether, ethylene glycol mono-2-ethylhexyl ether, diethylene glycol mono-2-ethylhexyl ether, triethylene glycol mono-2-ethylhexyl ether, diethylene glycol mono-2-ethyl pentyl ether, ethylene glycol mono-2-ethyl pentyl ether, ethylene glycol mono-2-methyl pentyl ether, and diethylene glycol mono-2-methyl pentyl ether.

Furthermore, in terms of increasing the color development properties of printed images with the aqueous ink composition and achieving a more uniform overcoat layer with the aqueous liquid composition, the alkyl group is more preferably a 2-methyl pentyl group, a 2-ethyl pentyl group, or a 2-ethyl hexyl group and is most preferably a 2-ethyl hexyl group as the branched structure of the glycol ethers. Specific examples include ethylene glycol mono-2-ethyl hexyl ether, diethylene glycol mono-2-ethyl hexyl ether, triethylene glycol mono-2-ethyl hexyl ether, diethylene glycol mono-2-ethyl pentyl ether, ethylene glycol mono-2-ethyl pentyl ether, ethylene glycol mono-2-methyl pentyl ether, and diethylene glycol mono-2-methyl pentyl ether. In particular, ethylene glycol mono-2-ethyl hexyl ether, diethylene glycol mono-2-ethyl hexyl ether, triethylene glycol mono-2-ethyl hexyl ether, and the like are preferable.

The content of the glycol ethers is preferably in the range of 0.1% by mass to 6% by mass based on the total amount of each of the aqueous ink composition and the aqueous liquid composition from the viewpoint of the effect of improving the wettability, storage stability, and ejection reliability of the aqueous ink composition and the aqueous liquid composition and the transparency of the overcoat layer with the aqueous liquid composition. When the content is lower than 0.1% by mass, the effects of the wettability and the permeability of the aqueous ink composition and the aqueous liquid composition to the recording medium decrease, which sometimes results in the fact that influences that concentration unevenness and bleeding are noticeable in printed images, the color development is poor, and the like are observed in the aqueous ink composition and influences that the abrasion resistance of the obtained printed images is poor, coating unevenness arises, and the like are observed in the aqueous liquid composition. When the content is larger than 6% by mass, the viscosity of the aqueous ink composition and the aqueous liquid composition become high, so that stable ejection becomes difficult, the solubility in the aqueous ink composition and the aqueous liquid composition is not obtained, so that stable storage properties over a long period of time is not obtained, or the transparency of the overcoat layer with the aqueous liquid composition after drying decreases in some cases.

### 1.1.3 1,2-Alkyldiols Having 4 to 8 Carbon Atoms

The aqueous ink composition and the aqueous liquid composition for use in the invention contain 1,2-alkyldiols having 4 to 8 carbon atoms (hereinafter also sometimes abbreviated as C4 to 8). Due to synergism with the glycol ethers mentioned above, C4 to 8 1,2-alkyldiols have an effect of further increasing the wettability of the aqueous ink composition and the aqueous liquid composition to recording media to thereby further improve the action of uniformly wetting the same on the recording media and the permeability. Therefore, by blending the C4 to 8 1,2-alkyldiols with the aqueous ink composition and the aqueous liquid composition, the concentration unevenness or bleeding on recording media can be further reduced in the aqueous ink composition and a uniform overcoat layer with less unevenness or hazing can be formed on recording media in the aqueous liquid composition. The C4 to 8 1,2-alkyldiols are excellent in compatibility with the glycol ethers mentioned above. Here, the “compatibility” refers to a combination, each material and the proportion of each material such that a mixture of the glycol ethers and the C4 to 8 1,2-alkyldiols completely dissolves in a composition containing water as the main solvent in each component constituting the aqueous ink composition and the aqueous liquid composition. By blending the C4 to 8 1,2-alkyldiols having excellent compatibility with the glycol ethers in the aqueous ink composition and the aqueous liquid composition, the solubility of the glycol ether in the aqueous ink composition and the aqueous liquid composition can be increased, and an increase in the storage stability and the ejection stability of the aqueous ink composition and the aqueous liquid composition can be realized. Since it becomes easy to increase the content of the glycol ethers into the aqueous ink composition and the aqueous liquid composition, a contribution to a further improvement of the printing quality can be achieved in the aqueous ink composition and the formation of a more uniform and more transparent overcoat layer can be achieved in the aqueous liquid composition.

Specific examples of the C4 to 8 1,2-alkyldiols having such properties include 1,2-butanediol, 1,2-pentane diol, 1,2-hexanediol, 1,2-heptane diol, 1,2-octane diol, and 4-methyl-1,2-pentane diol. Particularly among the above, C6 to 8 (The number of carbon atoms is 6 to 8.) 1,2-alkyldiols, such as 1,2-hexanediol, 1,2-heptane diol, and 1,2-octane diol, are more preferable from the viewpoint of the solubility in water and the compatibility with the glycol ethers.

When the number of carbon atoms is lower than 4, the effect of improving the wettability or the permeability of the aqueous ink composition and the aqueous liquid composition to recording media becomes insufficient and further the compatibility with the glycol ethers is not sufficient, which results in the fact that the glycol ethers cannot sufficiently dissolve in the aqueous ink composition and the aqueous liquid composition. When the number of carbon atoms is 9 or more, evaporation is difficult to occur, and thus the drying properties of the aqueous ink composition and the aqueous liquid composition decrease, which results in a reduction of the water resistance and abrasion resistance of printed materials.

The addition amount of the C4 to 8 1,2-alkyldiols is preferably 0.5 time to 5 times and more preferably twice to 5 times, in terms of mass ratio, the glycol ethers from the viewpoint of the compatibility with the glycol ethers. From the viewpoint of securing the compatibility with the glycol ethers and the storage stability and the ejection stability of the aqueous ink composition and the aqueous liquid composition, the addition amount is preferably in the range of 0.5% by mass to 20% by mass and more preferably in the range of 1% by mass to 8% by mass based on the total amount of the aqueous ink composition and the total amount of the aqueous liquid composition. When the content of the C4 to 8 1,2-alkyldiols is lower than 0.5% by mass, the solubility of the glycol ethers becomes insufficient and the wettability of the aqueous ink composition and the aqueous liquid composition to recording media becomes poor to thereby sometimes cause concentration unevenness, bleeding, and coating unevenness in printed materials to adversely affect the image quality and also the abrasion resistance of printed material after drying and the transparency of the overcoat layer with the aqueous liquid composition sometimes become insufficient. When the content is more than 20% by mass, it becomes difficult to set the viscosity of the aqueous ink composition and the aqueous liquid composition in a proper range in an ink jet recording method, and thus the ejection easily become unstable and also it becomes difficult to secure the storage stability of the aqueous ink composition and the aqueous liquid composition over a long period of time in some cases. When the content is in a preferable range of 1% by mass to 8% by mass, an evaporation and scattering rate, which is sufficient for drying, of C4 to 8 1,2-alkyldiols is obtained by performing a drying process to printed images formed with the aqueous ink composition and the aqueous liquid composition. Therefore, consequently, the printed materials are rabidly dried to thereby obtain a special effect of increasing the printing rate. Moreover, a problem of bad smell in a printing process does not arise.

### 1.1.4 Polymer Particles

The aqueous liquid composition for use in the invention contains polymer particles. When a printed image is recorded on a non-ink absorbing or low-ink absorbing recording medium, such as a vinyl chloride film or a polypropylene film, excellent abrasion resistance can be imparted to printed images formed with the aqueous ink composition by applying the aqueous liquid composition containing polymer particles to the surface thereof. This is because, in a drying process described in detail later, the polymer particles have action of being firmly fixing onto the recording medium. In particular, the polymer particles are preferably contained in a fine particle state (i.e., an emulsion state or a suspension state in the aqueous liquid composition for use in the invention). Based on the fact that the polymer particles are contained in a fine particle state, the viscosity of the aqueous liquid composition is easily adjusted in a proper range in an ink jet recording method and storage stability and ejection stability are easily secured.

Examples of components constituting the polymer particles include polyacrylic acid ester or a copolymer thereof, polymethacrylic acid ester or a copolymer thereof, polyacrylonitrile or a copolymer thereof, polycyanoacrylate, polyacrylamide, polyacrylic acid, polymethacrylic acid, polyethylene, polypropylene, polybutene, polyisobutylene, polystyrene, or copolymers thereof, petroleum resin, chroman indene resin, terpene resin, polyvinyl acetate, or a copolymer thereof, polyvinyl alcohol, polyvinyl acetal, polyvinyl ether, polyvinyl chloride or a copolymer thereof, polyvinylidene chloride, fluororesin, fluarorubber, polyvinyl carbazole, polyvinyl pyridine, polyvinyl imidazole, polybutadiene or a copolymer thereof, polychloroprene, polyisoprene, and a natural resin. Among the above, one having a hydrophobic portion and a hydrophilic portion in the molecular structure is particularly preferable.

As the polymer particles, one obtained by known materials and methods is also usable. For example, polymer particles described in Japanese Unexamined Patent Application Publication Nos, 62-1426, 3-56573, 3-79678, 3-160068, 4-18462, and the like may be used. Moreover, commercially available items can also be used, and examples include Micro Gel E-1002 and Micro Gel E-5002 (all trade names, manufactured by Nippon Paint Co., Ltd.), Boncoat 4001 and Boncoat 5454 (all trade names, manufactured by Dainippon Ink & Chemicals, Inc.), SAE1014 (trade name, manufactured by Nippon Zeon Co., Ltd.), Saibinol SK-200 (trade name, manufactured by Saiden Chemical Industry Co., Ltd.), JONCRYL 7100, JONCRYL 390, JONCRYL 711, JONCRYL 511, JONCRYL 7001, JONCRYL 632, JONCRYL 741, JONCRYL 450, JONCRYL 840, JONCRYL 74J, JONCRYL HRC-1645J, JONCRYL 734, JONCRYL 852, JONCRYL 7600, JONCRYL 775, JONCRYL 537J, JONCRYL 1535, JONCRYL ROX-7630A, JONCRYL 352J, JONCRYL 352D, JONCRYL PDX-7145, JONCRYL 538J, JONCRYL 7640, JONCRYL 7641, JONCRYL 631, JONCRYL 790, JONCRYL 780, and JONCRYL 7610 (all trade names, manufactured by Basf Japan, Inc.).

The polymer particles are obtained by the methods shown below, and any method of the methods is acceptable and two or more methods may be combined as required. Examples of the methods include a method including mixing a polymerization catalyst (polymerization initiator) and a dispersing agent in monomers of components constituting desired polymer particles, and polymerizing the same (i.e., emulsion polymerization), a method including dissolving a polymer component having a hydrophilic portion in a water soluble organic solvent, mixing the solution in water, and removing the water soluble organic solvent by distillation or the like, thereby obtaining polymer particles, and a method including dissolving a polymer component in a water-insoluble organic solvent, and mixing the solution in an aqueous solution with a dispersing agent, thereby obtaining polymer particles. The methods can be suitably selected as appropriate according to the type and the properties of the components to be used for constituting the polymer particles to be used. A dispersing agent that can be used for dispersing polymer particles into a fine particle state is not particularly limited and anionic surfactants (e.g., a sodium dodecylbenzenesulfonate salt, a laurylphosphate sodium salt, and a polyoxyethylene alkyl ether sulfate ammonium salt) and nonionic surfactants (e.g., polyoxyethylene alkyl ether, polyoxyethylene alkyl ester, polyoxyethylene sorbitan fatty acid ester, and polyoxyethylene alkyl phenyl ether) are mentioned. The surfactants can be used singly or as a mixture of two or more kinds thereof.

In terms of securing storage stability and ejection stability of the aqueous liquid composition, the average particle diameter of the polymer particles is preferably in the range of 5 nm to 300 nm and more preferably 90 nm to 150 nm.

The content of the polymer particles is preferably in the range of 0.1% by mass to 15% by-mass and more preferably in the range of 0.5% by mass to 10% by mass in terms of solid content based on the total amount of the aqueous ink composition. Based on the fact that the content is in the range above, a combination of the aqueous liquid composition and the drying process in the invention allows solidification and fixation of the overcoat layer with the aqueous liquid composition as a protective film of printed images also on a non-ink absorbing or low-ink absorbing recording medium. When the content is lower than 0.1% by mass, the strength of the solidification and fixation of the overcoat layer becomes weak, which sometimes resulting in easy separation from the recording medium surface. When the content exceeds 15% by mass, storage stability and ejection stability of the aqueous liquid composition cannot be secured in some cases.

With respect to resin components constituting the above-described polymer particles, at least one resin component having a minimum film forming temperature (hereinafter referred to as an “MFT”) of room temperature or more (generally 30° C. or more) is preferably contained. The MFT can be visually confirmed by thinly applying an emulsion of the polymer particles to an aluminum plate having a heater and a thermometer, for example. By containing a component having an MFT equal to or higher than room temperature, an effect of forming a stronger resin coat film is high in the drying process (particularly including a heating process). Therefore, the strength of the overcoat layer as a protective film of printed images becomes high, and consequently the abrasion resistance of printed materials becomes more favorable. Moreover, ink clogging at the nozzle tip of an ink jet head by an ink jet recording method is hard to occur. In contrast, when polymer particles containing only a component having an MFT lower than room temperature, a firm resin coat film is hard to be formed even when passing through a drying process, which sometimes results in the fact that the strength of the overcoat layer becomes low, and thus the abrasion resistance of printed materials becomes poor. Furthermore, an ink solidified substance is generated at the nozzle tip to easily cause clogging in some cases.

The polymer particles described above can be preferably used also for the aqueous ink composition for use in the invention. The effects and the addition amount may be the same as those of the aqueous liquid composition for use in the invention.

### 1.1.5 Wax Particles

The aqueous liquid composition for use in the invention contains wax particles. When the aqueous liquid composition containing the wax particles is applied onto printed images, an effect of imparting glossiness to the surface of the obtained printed material to increase the abrasion resistance is obtained.

As the components constituting the wax particles, plant and animal wax, such as carnauba wax, candelilla wax, beeswax, rice wax, and lanolin; petroleum wax, such as paraffin wax, microcrystalline wax, polyethylene wax, oxidized polyethylene wax, and petrolatum; mineral wax, such as montan wax and ozokerite; synthetic wax, such as carbon wax, Hoechst wax, polyolefin wax, and stearamide; natural and synthetic wax emulsion, such as α-olefin-maleic anhydride copolymer; compound wax, and the like can be used singly or as a mixture of two or more kinds thereof. Among the above, polyolefin wax is mentioned as a preferable wax type, and particularly polyethylene wax and polypropylene wax are preferable. As the wax particles, commercially available items may he used as they are and, examples include Nopcote PEM17 (trade name, manufactured by San Nopco Ltd.), Chemipearl W4005 (trade name, manufactured by Mitsui Chemicals, Inc.), and AQUACER 313 and AQUACER 593 trade names, manufactured by BYK Japan KK).

The average particle diameter of the wax particles is in the range of preferably 5 nm to 400 nm and more preferably 30 nm to 200 nm in terms of securing the storage stability and the discharge stability of the aqueous ink composition.

The content of the wax particles is preferably 0.1% by mass to 10% by mass and more preferably 0.5% by mass to 5% by mass in terms of solid content based on the total amount of the aqueous liquid composition. Based on the fact that the content is in the range above, a combination with the drying process described in detail later allows the wax particles to be present on the surface of the overcoat layer with the aqueous liquid composition formed on printed images to reduce frictional resistance and increase the abrasion resistance of printed images also on a non-ink absorbing or low-ink absorbing recording medium. When the content is lower than 0.1% by mass, the effect of reducing frictional resistance becomes low, and consequently printed images easily separate from the recording medium surface in some cases. When the content exceeds 10% by mass, the storage stability and the ejection stability of the aqueous liquid composition cannot be secured in some cases.

Although the reason why the combined use of the wax particles and the above-described polymer particles improves the abrasion resistance of printed materials is not clear, the reason is presumed as fellows. Since the components constituting the polymer particles have a high affinity for a non-ink absorbing or low-ink absorbing recording medium and a water-insoluble colorant, the polymer particles applied onto printed images in the drying precess form a resin coat film in such a manner as to cover the surface of the printed images to be firmly fixed thereto due to heat. In contrast, the components of the wax particles are also present on the surface of a polymer particle resin coat film and have properties of reducing the frictional resistance of the surface of the resin coat film. Thus, a resin coat film that is hard to chip due to rubbing from the outside and is hard to separate from the recording medium can be formed, which is presumed to improve the abrasion resistance of printed materials.

As a method for printing the liquid composition according to an embodiment of the invention in such a manner as to cover the printed image formed with the aqueous ink composition, a method including printing and applying the liquid composition in an area larger than the printed image formed with the aqueous ink composition rather than a method including merely printing the liquid composition in such a manner as to cover the printed image formed with the aqueous ink composition, in order to further suppress the separation of the medium and the printed image at the interface therebetween. With the structure, a resin coat film formed with the polymer particles is formed in such a manner as to completely cover the printed image formed with the aqueous ink composition. The liquid composition according to an embodiment of the invention contains glycol ethers having an HLB value calculated by the Davis method in the range of 4.2 to 8.0 and thus has sufficient affinity with a non-ink absorbing or low-ink absorbing medium. Therefore, the resin coat film formed with the polymer particles is formed in such a manner as to completely cover the printed image to be more firmly fixed to the recording medium, and consequently the printed image to be obtained can obtain high abrasion resistance.

The content ratio of the polymer particles and the wax particles contained in the aqueous liquid composition is preferably in the range of Polymer particles: Wax particles=1:1 to 5:1 in terms of solid content. When the content ratio is in the range above, the above-described mechanism favorably works, and thus the abrasion resistance of printed materials becomes favorable.

The wax particles described above can be preferably used also for the aqueous ink composition for use in the invention. The effects and the addition amount thereof may be the same as those of the aqueous liquid composition for use in the invention.

### 1.1.6 Water

The aqueous ink composition and the aqueous liquid composition for use in the printing method according to an embodiment of the invention contain water. Water is a main medium of the aqueous ink composition and the aqueous liquid composition and is a component that evaporates and scatters in the drying process described in detail later.

The water is preferably water from which ionic impurities are removed as much as possible, such as pure water, such as ion exchanged water, ultrafiltration water, reverse osmesis water, or distilled water, or ultrapure water. When water that has been sterilized by UV irradiation or addition of hydrogen peroxide is used, the development of mold or bacteria can be prevented when the aqueous liquid composition is stored over a long period of time, and thus such water is preferable.

### 1.1.7 Other Preferable Constituent Materials

The aqueous ink composition for use in the printing method using ink jet recording according to an embodiment of the invention at least contains a water insoluble colorant, glycol ethers having an HLB value calculated by the Davis method in the range of 4.2 to 8.0, C4 to 8 1,2-alkyldiols, and water. Similarly, the aqueous liquid composition at least contains glycol ethers having an HLB value calculated by the Davis method in the range of 4.2 to 8.0, C4 to 8 1,2-alkyldiols, polymer particles, wax particles, and water. With the structure, the wettability and the penetration rate can be controlled without being hardly influenced by a recording medium type and clear printed images having less concentration unevenness, high color development, and less bleeding can be obtained on various recording media in the case of the aqueous ink composition. Moreover, the storage stability is favorable and the ejection stability of small ink droplets by an ink jet recording method is excellent. The wettability and the penetration rate can be controlled without being influenced by a recording medium type and an overcoat layer having less coating unevenness and high transparency can be obtained on various recording media in the case of the aqueous liquid composition. Moreover, the storage stability is favorable and the ejection stability of small ink droplets by an ink jet recording method is excellent. In order to further increase the properties in the aqueous ink composition and the aqueous liquid composition, the following various materials can be preferably further added.

### 1.1.7.1 Nonionic Surfactant

The aqueous ink composition and the aqueous liquid composition for use in the printing method according to an embodiment of the invention preferably contain a nonionic surfactant. The nonionic surfactant has action of uniformly spreading the aqueous ink composition and the aqueous liquid composition on a recording medium. Therefore, the use of the aqueous ink composition containing the same has an effect of obtaining clearer images having less concentration unevenness or less bleeding. When the aqueous liquid composition containing the same is used, an effect of obtaining an overcoat layer without coating unevenness or hazing is demonstrated. Examples of the nonionic surfactants having such an effect include a polyoxyethylene alkyl ether type, a polyoxypropylene alkyl ether type, a polycyclic phenyl ether type, a sorbitan derivative, a fluorine type, a silicone type, and an acetyleneglycol type. Among the above, a silicone surfactant and an acetyleneglycol surfactant are preferable because they are excellent particularly in the above-described effects and has excellent compatibility and synergistic effects with the glycol ethers and the C4 to 8 1,2-alkyldiols indispensable in the aqueous ink composition and the aqueous liquid composition for use in the printing method according to an embodiment of the invention.

### 1.1.7.1.1 Silicone Surfactant

The aqueous ink composition and the aqueous liquid composition for use in the printing method according to an embodiment of the invention preferably contain a silicone surfactant. The silicone surfactant is excellent in the action of uniformly spreading the aqueous ink composition and the aqueous liquid composition in such a manner as not to cause concentration unevenness, bleeding, or coating unevenness on a recording medium as compared with other nonionic surfactants. The silicone surfactant is also excellent in the compatibility and synergistic effects of the properties with the glycol ethers and the C4 to 8 1,2-alkyldiols indispensable in the aqueous ink composition. The content of the silicone surfactant is preferably in the range of 1.5% by mass or lower based on the total amount of each of the aqueous ink composition and the aqueous liquid composition for use in the printing method according to an embodiment of the invention. When the content of the silicone surfactant exceeds 1.5% by mass, the storage stability and the ejection stability of the aqueous ink composition and the aqueous liquid composition cannot be secured in some cases.

As the silicone surfactant, polysiloxane compounds and the like are preferably used and, for example, a polyether-modified organosiloxane and the like are mentioned. In more detail, examples include BYK-306, BYK-307, 3YK-333, BYK-341, BYK-345, BYK-346, and BYK-348 (trade names, manufactured by BYK chemmie Japan, Inc.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemicals Co., Ltd.).

### 1.1.7.1.2 Acetyleneglycol Surfactant

The aqueous ink composition and the aqueous liquid composition for use in the printing method according to an embodiment of the invention preferably contain an acetylene glycol surfactant. The acetylene glycol surfactant is excellent in the capability of appropriately keeping the surface tension and the interfacial tension as compared with other nonionic surfactants and has properties of less foamability. Thus, the aqueous ink composition and the aqueous liquid composition containing the acetylene glycol surfactant can appropriately keep the surface tension and the interfacial tension with a printer member contacting ink, such as a head nozzle surface. Therefore, when the aqueous ink composition and the aqueous liquid composition containing the acetylene glycol surfactant are applied to an ink jet recording method, the ejection stability can be increased. Moreover, since the acetylene glycol surfactant acts as a favorable wettability and penetration agent to a recording medium similarly as the glycol ethers and the C4 to 8 1,2-alkyldiols, the printed image with the aqueous ink composition containing the same or the overcoat layer with aqueous liquid composition containing the same becomes one having a high resolution and having less concentration unevenness or less hazing. The content of the acetylene glycol surfactant is preferably 1.0% by mass or lower based on the total amount of each of the aqueous ink composition and the aqueous liquid composition. When the content of the acetylene glycol surfactant exceeds 1.0%, by mass, the storage stability and the ejection stability of the aqueous ink composition and the aqueous liquid composition cannot be secured in some cases.

Examples of the acetyleneglycol surfactant include Surfinol 104, 104E, 109H, 104A, 104BC, 104DPM, 104PA, 104PG-50, 104S, 420, 440, 465, 485, SE, SE-F, 504, 61, DF37; CT111, CT121, CT131, CT136, TG, GA, and DF110D (trade names, manufactured by Air Products and Chemicals. Inc.), Olfine B, Y, P, A, STG, SPC, E1004, E1010, PD-001, PD-002W, PD-003, PD-004, EXP. 4001, EXP. 4036, EXE. 4051, AF-103, AF-104, AK-02, SK-19, and AE-3 (all trade names, manufactured by Nisshin Chemical Industry Co., Ltd.), Acetylenol E00, E00P, E40, and E100 (trade names, manufactured by Kawaken Fine Chemicals Co., Ltd.).

### 1.1.7.2 Pyrolidorie Derivative

The aqueous ink composition and the aqueous liquid composition for use in the printing method according to an embodiment of the invention preferably contain a pyrrolidone derivative. The pyrrolidone derivative has an effect of acting as a favorable solubilizer or softener for the polymer particles described above. The pyrrolidone derivative has action of promoting the formation of a coat film with the polymer particles during drying of the aqueous ink composition and the aqueous liquid composition ejected onto a non-ink absorbing or low-ink absorbing recording medium to thereby promote solidification and fixation of the ink on the recording medium. The content of the pyrrolidone derivative is preferably 10% by mass or lower based on the total amount of each of the aqueous ink composition and the aqueous liquid composition. When the content of the pyrrolidone derivative exceeds 10% by mass, the evaporation and scattering of the pyrrolidone derivative becomes insufficient even when passing through a drying process, resulting in the fact that the drying of printed materials becomes insufficient and a problem of bad smell arises in some cases.

Examples of the pyrrolidone derivative include low molecular compounds, such as N-methyl-2-pyrrolidone, N-ethyl-2-pyrrolidone, N-vinyl-2-pyrrolidone, 2-pyrrolidone, N-butyl-2-pyrrolidene, and 5-methyl-2-pyrrolidone. Particularly among the above, 2-pyrrolidone is preferable in terms of securing storage properties of the aqueous ink composition and the aqueous liquid composition for use in the printing method according to an embodiment of the invention, promoting the formation of a coat film of a resin fixing agent, and having relatively less bad smell.

### 1.1.7.3 Polyhydric Alcohol

The aqueous ink composition and the aqueous liquid composition for use in the printing method according to an embodiment of the invention preferably contain polyhydric alcohol. Polyhydric alcohols have action of suppressing drying and solidification of ink at the nozzle surface of an ink jet head, to prevent clogging or poor ejection, and is preferably one having a high vapor pressure. This is because it is preferable for the polyhydric alcohols to evaporate and scatter with moisture in the drying process. The content of the polyhydric alcohols is preferably in the range of 20% by mass or lower based on the total amount of each of the aqueous ink composition and the aqueous liquid composition. By the addition of the polyhydric alcohols in this range above, the above-described effects are demonstrated. When the content exceeds 20% by mass, even when it passes through the drying process, the evaporation and scattering of the polyhydric alcohols become insufficient, resulting in the fact that the drying of printed materials becomes insufficient and a problem of bad smell arises in some cases.

Examples of the polyhydric alcohols include, other than C4 to 8 1,2-alkylene dials, ethylene glycol, diethylene glycol, triethylene glycol, propylene glycol, dipropyrene glycol, 1,3-propane diol, and 1,4-butanediol. Among the above, ethylene glycol, diethylene glycol, triethylene glycol, propylene glycol, and dioropyrene glycol are preferable from the viewpoint of a birth vapor pressure and not impairing the drying properties of the aqueous ink composition after printing.

### 1.1.7.4 Pyrolidone Resin Derivative

The aqueous ink composition and the aqueous liquid composition for use in the printing method according to an embodiment of the invention can preferably contain a pyrrolidone resin derivative. The pyrrolidone resin derivative in the invention is selected from substances exhibiting water solubility. The pyrrolidone resin derivative is different from the above-described pyrrolidone derivative in the function and has an effect of increasing the wettability of the aqueous ink composition and the aqueous liquid composition containing the same to film media and also increasing the abrasion resistance of printed images. When a film-type non-ink absorbing recording medium containing polyvinyl chloride, polyethylene terephthalate, polyethylene, polypropylene, or the like is used as a recording medium, the pyrrolidone resin derivative has properties that wetting and spreading become uniform when small droplets of the aqueous ink composition and the aqueous liquid composition are attached and thus, in the case of the aqueous ink composition, printed images having less concentration unevenness or bleeding are obtained and, in the case of the aqueous liquid composition, a uniform overcoat layer having less unevenness or cissing is obtained. Although the reason is not clear, it is presumed that since the pyrrolidone structure contained in the molecular skeleton structure of the pyrrolidone resin derivative has high affinity with the film recording medium, the wettability to a film increases also in the aqueous ink composition and the aqueous liquid composition containing the same.

As such a pyrrolidone resin derivative, reagents or commercially available items can be used as they are. Specific examples of the reagents include polyvinyl pyrrolidone K-15, polyvinyl pyrrolidone K-30, polyvinyl pyrrolidone K-60, polyvinyl pyrrolidone K-90, and a poly(1-vinylpyrrolidone-co-vinyl acetate)copolymer (all manufactured by Tokyo Kasei Kogyo Co., Ltd.) and an N-vinyl pyrrolidone/styrene copolymer and an N-vinylpyrrolidone/diethyl amino methyl methacrylate copolymer (all manufactured by Junsei Chemical Co., Ltd.). As the commercially available items, mentioned in detail are Luviskol K17 (polyvinyl pyrrolidone), Luviskol K30 (polyvinyl pyrrolidone), Luviskol K90 (polyvinyl pyrrolidone), Luviskol VA73E; (vinyl acetate-vinylpyrrolidone copolymer), Luviskol VA64P (vinyl acetate-vinylpyrrolidone copolymer), Luviskol VA55I (vinyl acetate-vinylpyrrolidone copolymer), Luviskol VA37E (vinyl acetate-vinylpyrrolidone copolymer), Luviskol VA37I (vinyl acetate-vinylpyrrolidone copolymer), Luviskol Plus (polyvinyl caprolactam), and Luviset Clear (<vinyl pyrrolidone/methacrylamide/vinyl imidazole>copolymer) (all manufactured by BASF Japan, Inc.), and the like.

The above-described pyrrolidone resin derivative can be added with an amount required for imparting desired properties to the aqueous ink composition and the aqueous liquid composition according to an embodiment of the invention. A preferable addition amount is in the range of 10% by mass or lower based on the total amount of each of the aqueous ink composition and the aqueous liquid composition. When the addition amount is in the range above, the above-described properties can be imparted to the aqueous ink composition and the aqueous liquid composition and the viscosity of the aqueous ink composition and the aqueous liquid composition is easily adjusted in a proper range in an ink jet recording method. In contrast, when the addition amount exceeds 10% by mass, the drying properties of printed images with the aqueous ink composition and the drying properties of an overcoat layer with the aqueous liquid composition decrease.

### 1.1.8 Other Additives

To the aqueous ink composition and the aqueous liquid composition for use in the printing method according to an embodiment of the invention, a penetration solvent, a moisturizer, an antiseptic and antifungal agent, a pH adjuster, a chelating agent, and the like other than the above-described preferable constituent materials can be added in terms of further increasing the properties.

The penetration solvent has action of further increasing the wettability of the aqueous ink composition and the aqueous liquid composition to recording media for uniform wetting. Thus, the concentration unevenness or bleeding of ink of formed images or coating unevenness of the liquid composition can be further reduced. Mentioned as the penetration solvent is, for example, the above-described glycol ethers having an HLB value calculated by the Davis method in the range of 4.2 to 8.0 and monohydric alcohol.

Examples of the glycol ethers include diethylene glycol monopropyl ether, ethylene glycol monoisopropyl ether, diethylene glycol monoisopropyl ether, 1-methyl-1-methoxy butanol, propylene glycol monomethyl ether, and propylene glycol monoethyl ether.

Examples of the monohydric alcohol include water soluble one, such as methanol, ethanol, n-propyl alcohol, isopropyl alcohol, 2,2-dimethyl-1-propanol, n-butanol, 2-butanol, tertiary butanol, isobutanol, 2-methyl-1-butanol, 3-methyl-1-butanol, 3-methyl-2-butanol, n-pentanol, 2-pentanol, 3-pentanol, and tertiary pentanol.

The content of the penetration solvent is preferably 10% by mass or lower and more preferably 8% by mass or lower based on the total amount of each of the aqueous ink composition and the aqueous liquid composition.

The moisturizer has action of suppressing evaporation of water in the aqueous ink composition and the aqueous liquid composition to prevent condensation of the solid content in the aqueous ink composition and the aqueous liquid composition. Examples of the moisturizer include glycerin, tetraethylene glycol, polyethylene glycol, polypropylene glycol, 1,5-pentanediol, 2,3-butanediol, 2-methyl-2,4-pentanediol, 2-ethyl-1,3-hexanediol, 1,2,6-hexanetriol, pentaerythritol, 1,6-hexanediol, 1,8-octanediol, 2,2-dimethyl-1,3-propanediol, 2,2-diethyl-1,3-propanediol, trimethylol ethane, trimethylolpropane, urea, 2-imidazolidinone, thio urea, and 1,3-dimethyl-2-imidazolidinone.

The content of the moisturizer is preferably 10% by mass or lower and more preferably 5% by mass or lower based on the total amount of each of the aqueous ink composition and the aqueous liquid composition. When the content of the moisturizer exceeds 10% by mass, the drying rate of the aqueous ink composition and the aqueous liquid composition become excessively low and the formation of a coat film with the polymer particles is hindered in some cases. Therefore, the solidification and fixation of the aqueous ink composition and the aqueous liquid composition on a recording medium are hindered to cause separation of the printed surface of printed materials in some cases.

Examples of the pH adjuster include potassium dihydrogen phosphate, disodium hydrogen phosphate, sodium hydroxide, lithium hydroxide, potassium hydroxide, ammonia, diethanolamine, triethanolamine, triisopropanolamine, potassium carbonate, sodium carbonate, and sodium hydrogencarbonate.

Examples of the antiseptic and antifungal agent include sodium benzoate, sodium pentachlorophenol, sodium 2-pyridinethiol-1-oxide, sodium sorbite, sodium dehydroacetate, and 1,2-dibenzisothiazolin-3-one. Examples of commercially available items include Proxel XL2 and Proxel GXL (all trade names, manufactured by Avecia) and Denicide CSA and NS-500W (all trade names, manufactured by Nagase ChemteX Corp.).

Examples of anti-rust agents include benzotriazole.

Examples of the chelating agent include ethylenediaminetetraacetic acid and a salt thereof (e.g., ethylenediaminetetraacetic acid calcium disodium salt dihydrate).

### 1.1.9 Physical Property Values of Aqueous Ink Composition and Aqueous Liquid Composition

The pH of the aqueous ink composition and the aqueous liquid composition for use in the printing method according to an embodiment of the invention is preferably neutral or alkaline and more preferably in the range of 7.0 to 10.0. When the pH is acidic, the storage stability and dispersion stability of the aqueous ink composition and the aqueous liquid composition are deteriorated in some cases. Moreover, defects, such as corrosion or the like of metal parts for use in an ink flow path in an ink jet recording device, easily occurs. The pH can be adjusted to neutrality or alkalinity using the above-described pH adjuster.

The viscosity of the aqueous ink composition and the aqueous liquid composition for use in the printing method according to an embodiment of the invention is preferably in the range of 1.5 mPa·s to 15 mPa·s at 20° C. When the viscosity is in the range above, the ejection stability of the aqueous ink composition and the aqueous liquid composition can be secured in a first printing process and a second printing process described later.

The surface tension of the aqueous ink composition and the aqueous liquid composition for use in the printing method according to an embodiment of the invention is preferably 15 mN/m to 40 mN/m and more preferably 20 mN/m to 35 mN/m at 25° C. When the surface tension is in the range above, the ejection stability of the aqueous ink composition and the aqueous liquid composition can be secured in the first printing process and the second printing process described later and proper wettability to a non-ink absorbing or low-ink absorbing recording medium can be secured.

### 1.1.10 Method for Manufacturing Aqueous Ink Composition and Aqueous Liquid Composition

The aqueous ink composition and the aqueous liquid composition for use in the printing method according to an embodiment of the invention are obtained by mixing the above-described materials in an arbitrary order, and filtrating or the like the mixture to remove impurities as required. Here, a colorant for use in the aqueous ink composition is preferably mixed after preparing the same into a dispersion liquid state in which the colorant is uniformly dispersed in an aqueous medium in terms of ease of handling and the like.

As a method for mixing each material, a method for successively adding materials in a container having a stirring device, such as a mechanical stirrer or a magnetic stirrer, and stirring and mixing the materials is preferably used. As the filtration method, centrifugal filtration, filter filtration, or the like can be performed as required.

### 2. Printing Process

Next, each process of the printing method using ink jet recording in the printing method according to an embodiment of the invention will be described in detail.

The printing process in the printing method according to an embodiment of the invention includes a first printing process for ejecting liquid droplets of the above-described aqueous ink composition onto a recording medium by an ink jet recording method to form printed images and a second printing process for printing the above-described aqueous liquid composition in such a manner as to cover the printed image printed with the aqueous ink composition.

### 2.1 First Printing Process (Printing Processes of Aqueous Ink Composition)

The first printing process (printing process of the aqueous ink composition) in the printing method according to an embodiment of the invention is a process for ejecting liquid droplets of the above-described aqueous ink composition onto a recording medium by an ink jet recording method to form printed images.

Any method can be used as the ink jet recording method insofar as the method includes ejecting the above-described aqueous ink composition as liquid droplets from a minute nozzle, and attaching the liquid droplets to a recording medium. As the ink jet recording method, the following fours methods are mentioned, for example.

A first method is referred to as an electrostatic suction method and is a method for recording an image by applying a strong electric field to a space between a nozzle and accelerating electrodes located in front of the nozzle, continuously jetting ink droplets from the nozzle, supplying printing information signals between deflecting electrodes while the ink droplets are flying between the deflecting electrodes or a method for recording an image by jetting ink droplets according to printing information signals without deflecting the ink droplets.

A second method is a method including applying pressure to an ink liquid with a small-size pump to mechanically vibrate a nozzle with a quartz oscillator or the like to thereby forcibly jet ink droplets. The jetted ink droplets are electrically charged simultaneously with being jetted, and printing information signals are supplied to deflecting electrodes while the ink droplets are flying between the deflecting electrodes for recording.

A third method is a method using a piezoelectric element and the method includes simultaneously applying pressure and printing information signals to an ink liquid by a piezoelectric element; and jetting and recording ink droplets.

A fourth method is a method for rapidly expanding the volume of a ink liquid by the action of thermal energy and the method includes heating the ink liquid with a micro electrode for foaming according to printing information signals, and jetting and recoding ink droplets.

Any recording medium can be used as the recording medium as desired. In the invention, a non-ink absorbing or low-ink absorbing recording medium is used. Examples of the non-ink absorbing recording medium include one in which plastics are coated on a base material, such as a plastic film or paper that has not been surface treated for ink jet printing (i.e., an ink absorption layer is not formed) and one in which a plastic film has been attached thereto. Examples of the plastics mentioned here include polyvinyl chloride, polyethylene terephthalate, polycarbonate, polystyrene, polyurethane, polyethylene, and polypropylene. Examples of a low-ink absorbing recording medium include printing paper, such as art paper, coat paper, and mat paper.

Here, the “non-ink absorbing and low-ink absorbing recording medium” in this specification refers to a “recording medium in which the water absorption amount from the initiation of contact to 30 msec:/2 is 10 mL/m2 or lower in the Bristow method”. This Bristow method is the most spread method as a method for measuring the liquid absorption amount in a short time and is employed also in the Japan Technical Association of the Pulp and Paper Industry (JAPAN TAPPI). The details of a test method are described in “Liquid Absorbency Test Method of Paper and Paperboard (Bristow Method) of No. 51 of “JAPAN TAPPI paper pulp test method, 2000”.

### 2.2 Second Printing Process (Printing Process of Aqueous Liquid Composition)

A second printing process (printing process of an aqueous liquid composition) in the printing method according to an embodiment of the invention is a process for ejecting liquid droplets of the above-described aqueous liquid composition in such a manner as to cover the printed image printed by the first printing process (printing process of an aqueous ink composition). By printing the aqueous liquid composition after printing the aqueous ink composition, an overcoat layer with the aqueous liquid composition is formed in such a manner as to cover the front surface side of the printed surface, and thus the abrasion resistance of the printed surface can be improved. The method for ejecting the aqueous liquid composition onto a recording medium by an ink jet recording method can be carried out in the same manner as in the case of the aqueous ink composition.

In addition, by selectively ejecting the aqueous liquid composition using an ink let record method, the aqueous liquid composition can be effectively attached in such a manner as to cover the printed image formed with the aqueous ink composition, and thus the consumption amount of the aqueous liquid composition can be reduced to the minimum necessary amount. Moreover, the generation of curling observed after drying when a large amount of the aqueous liquid composition is attached to the entire surface of paper can be suppressed.

The method for recording the aqueous liquid composition onto a recording medium may be a multi-pass mode or a single pass mode, and recording with a single pass mode or a two pass mode is preferable from the viewpoint of high speed printing. Here, the single pass mode is a method for recording all dots to be recorded in a scanning region through a single scan of a recording head. The two pass mode is a method for recording all dots to be recorded in the scanning region of a recording head through two scans of the recording head. In addition, the single-pass recording method includes, for example, a method including recording dots through a single scan of a recording head in a main scanning direction, moving a recording medium corresponding to a recording region in a sub-scanning direction, and repeating the operations to form the entire image and a method in which a recording head is fixed and a recording medium is scanned to form an image. Both of the methods can be preferably used. Single-pass or two-pass recording achieves high speed printing, which increases the productivity of recorded materials.

### 2.3 Drying Process

The drying process in the printing method according to an embodiment of the invention includes a “drying process during printing process” including evaporating a water component mainly present as a liquid component in the printed image with the aqueous ink composition ejected onto the recording medium in the above-described “first, printing process (printing processes of the aqueous ink composition)” and the “second printing process (printing processes of the aqueous liquid composition)” and the overcoat layer formed covering the printed image with the aqueous liquid composition to thereby fix the printed image and the overcoat layer and a “drying process after printing process” including completely drying a solvent component present in the printed images or the overcoat layer on the recording medium after each printing process of the above-described “first printing process (printing process of the aqueous ink composition)” and the “second printing process (printing processes of the aqueous liquid composition)” to thereby fix the remaining solid content onto the recording medium. In the printing method according to an embodiment of the invention, the drying process is performed at a timing of at least either one of during printing in the first printing process, after printing in the first printing process, during printing in the second printing process, and after printing in the second printing process. In order to obtain a printed material with a higher resolution and further improved abrasion resistance, the drying process is preferably carried out both during and after printing in the first printing process and the second printing process. The “drying process after printing process” is preferably carried out at a temperature higher than that of the “drying process during printing processes” in each of the first printing process and the second printing process for the reason described later.

A drying method in the drying process is not particularly limited insofar as the evaporation and scattering of a liquid medium present in the printed image are promoted. Examples include a method for applying heat to the recording medium, a method for applying air to the printed image on the recording medium, and a method in which the two methods are combined. Specifically, the method for applying air to the printed image on the recording medium is preferable in the “drying process during printing process” and the method for applying heat to the printed image on the recording medium is preferable in the “drying process after printing process”. In addition, examples of preferable drying methods include radiation heating, conductive heating, high frequency drying, and microwave drying.

By incorporating the “drying process during printing process”, the water component contained in the aqueous ink composition or the aqueous liquid composition ejected onto the recording medium evaporates to increase the viscosity. Thus, bleeding due to flowing of the printed image on the recording medium or coating unevenness of the overcoat layer can be prevented and the printed image and the overcoat layer can be fixed.

More specifically, according to the confirmation of the present inventors by an experiment, it has been confirmed that water mainly in the printed image promptly evaporates by heating the printed image on the recording medium at 40° C. In such a state, other solvent components in the printed image remain in no small amount but the viscosity increases to a degree in which concentration unevenness/bleeding or coating unevenness does not proceed in the printed image and the fluidity is lost and high resolution images with less concentration unevenness/bleeding or coating unevenness can be secured also on a non-ink absorbing or low-ink absorbing recording-medium, such as a plastic film having no ink absorption layer. The heating temperature in this case is not particularly limited insofar as the water components present in the aqueous ink composition and the aqueous liquid composition can evaporate. The effect is obtained when the heating temperature is 40° C. or higher, and a temperature of about 40° C. to about 50° C. is preferable. When the temperature exceeds 60° C., ink near a nozzle of an ink jet head is influenced by heat to condense the solid content in the aqueous ink composition or the aqueous liquid composition, resulting in the fact that defects, such as clogging of a nozzle of an ink jet head, frequently occur.

The “drying process after printing process” is a process for completely evaporating and scattering the solvent component present in the aqueous ink composition or the aqueous liquid composition to promote fusion of resin components, such as polymer particles, contained in the aqueous ink composition or the aqueous liquid composition to form an excellent coat film to thereby secure abrasion resistance of a recorded material. The heating temperature is not particularly limited insofar as the solvent components present in the aqueous ink composition and the aqueous liquid composition evaporates and a coat film of the resin components, such as polymer particles, can be formed. The effects are obtained when the heating temperature is 50° C. or higher, and a temperature of about 50° C. to about 80° C. is preferable and a temperature of about 50° C. to about 60° C. is more preferable. When the heating temperature exceeds 80° C., deformation or the like arises depending on a recording medium type, and thus defects sometimes occur in transport. The “drying process after printing process” is preferably carried out in such a manner as not influence an ink jet head due to heat and may be carried out while securing a sufficient distance.

Although the “drying process during printing process” is preferably carried out during printing of each of the “first printing process” and the “second printing process”, the “drying process after printing processes” may be carried out after both the printing processes of the “first printing process” and the “second printing process” are completed. This is because the water component which is the main solvent in the ink composition evaporates by carrying out the “drying process during printing processes” to increase the viscosity as described above, and thus the printed image on the recording medium loses the fluidity. Even when the “second printing process” is carried out following the “first printing process”, bleeding of the printed image does not occur on the recording medium.

The drying/heating time is not particularly limited insofar as the liquid medium present in the aqueous ink composition and the aqueous liquid composition evaporates and a coat film of resin components, such as polymer particles, can be formed and can be determined as appropriate considering the type of the liquid medium to be used, the type of the resin to be used, and the printing rate to be used.

### EXAMPLES

Hereinafter, the invention will be described in detail with reference to Examples but is not limited thereto.

### 3. Examples

### 3.1 Preparation of Aqueous Liquid Composition and Aqueous Ink Composition

Polymer particles to be added to an aqueous liquid composition were prepared as a dispersion liquid (emulsion) containing the polymer particles as dispersed particles, and then the materials shown in Table 2 were mixed, thereby preparing an aqueous liquid composition.

First, a method for preparing each dispersion liquid of the polymer particles will be described below. With respect to the “MFT”, the emulsion was thinly applied to an aluminum plate having a heater and a thermometer, and then the temperature at which the particles dissolved to form a coat was visually confirmed. The particle diameter is a value of the average particle diameter determined by particle size distribution measurement with Microtrac UPA150 (trade name, manufactured by Microtrac).

### 3.1.1 Preparation of Polymer Particle Dispersion Liquid 1

In a reaction container having a stirrer, a reflux capacitor, a dropping device, and a thermometer, 1,000 g of ion exchanged water and 3 g of sodium lauryl sulfate were charged, and the temperature was increased to 70° C. under stirring with nitrogen replacement. The internal temperature was held at 70° C., and 4 g of potassium peroxodisulfate was added as a polymerization initiator. After dissolution, an emulsion that was produced beforehand by adding, under stirring, 20 g of acryl amide, 455 g of styrene, 485 g of 2-ethylhexyl acrylate, 30 g of methacrylic acid, and 2 g of ethylene glycol dimethacrylate to 500 g of ion exchanged water and 3 g of sodium lauryl sulfate was continuously added dropwise in a reaction solution over 4 hours. After the completion of the dropwise addition, the mixture was matured for 3 hours. Thereafter, ion exchanged water and aqueous ammonia were added, thereby obtaining a polymer particle dispersion liquid 1 (MFT: 50° C., Average particle diameter: 50 nm) having a solid content concentration of 30% by mass and a pH of 8.

### 3.1.2 Preparation of Polymer Particle Dispersion Liquid 2

In a reaction container having a stirrer, a reflux capacitor, a dropping device, and a thermometer, 800 g of ion exchanged water and 3 g of sodium lauryl sulfate were charged, and the temperature was increased to 70° C. under stirring with nitrogen replacement. The internal temperature was held at 70° C., 4 g of potassium peroxodisulfate was added as a polymerization initiator. After dissolution, an emulsion that was produced beforehand by adding, under stirring, 20 g of acryl amide, 755 g of styrene, 295 g of butyl acrylate, and 30 g of methacrylic acid to 450 g of ion exchanged water and 2.5 g of sodium lauryl sulfate was continuously added dropwise in a reaction solution over 4 hours. After the completion of the dropwise addition, the mixture was matured for 3 hours. Thereafter, ion exchanged water and an aqueous sodium hydroxide solution were added, thereby obtaining a polymer particle dispersion liquid 2 (MFT: 80° C., Average particle diameter: 10 nm) having a solid content concentration of 30% by mass and a pH of 8.

### 3.1.3 Preparation of Polymer Particle Dispersion Liquid 3

In a reaction container having a stirrer, a reflux capacitor, a dropping device, and a thermometer, 900 g of ion exchanged water and 3 g of sodium lauryl sulfate were charged, and the temperature was increased to 70° C. under stirring with nitrogen replacement. The internal temperature was held at 70° C., 4 g of potassium peroxodisulfate was added as a polymerization initiator. After dissolution, an emulsion that was produced beforehand by adding, under stirring, 20 g of acryl amide, 245 g of styrene, 295 g of methyl methacrylate, 500 g of butyl acrylate, and 30 g of methacrylic acid to 450 g of ion exchanged water and 3 g of sodium lauryl sulfate was continuously added dropwise in a reaction solution over 4 hours. After the completion of the dropwise addition, the mixture was matured for 3 hours. Thereafter, ion exchanged water and a 5% aqueous sodium hydroxide solution were added, thereby obtaining a polymer particle dispersion liquid 3 (MFT: 30° C., Average particle diameter: 50 nm) having a solid content concentration of 30% by mass and a pH of 8.

### 3.1.4 Preparation of Polymer Particle Dispersion Liquid 4

In a reaction container having a stirrer, a reflux capacitor, a dropping device, and a thermometer, 900 g of ion exchanged water and 1 g of sodium lauryl sulfate were charged, and the temperature was increased to 70° C. under stirring with nitrogen replacement. The internal temperature was held at 70° C., 4 g of potassium peroxodisulfate was added as a polymerization initiator. After dissolution, an emulsion that was produced beforehand by adding, under stirring, 20 g of acryl amide, 300 g of styrene, 640 g of butyl acrylate, and 30 g of methacrylic acid to 450 g of ion exchanged water and 3 g of sodium lauryl sulfate was continuously added dropwise in a reaction solution over 4 hours. After the completion of the dropwise addition, the mixture was matured for 3 hours. Thereafter, ion exchanged water and a 5% aqueous sodium hydroxide solution were added, thereby obtaining a polymer particle dispersion liquid 4 (MET: 40° C., Average particle diameter: 90 nm) having a solid content concentration of 30% by mass and a pH of 8.

### 3.1.5 Preparation of Polymer Particle Dispersion Liquid 5

As a polymer particle dispersion 5, JONCRYL 538J (trade name, manufactured by Basf Japah, NET: 50° C., Average particle diameter: 100 nm, Solid content: 45%) was used.

### 3.1.6 Preparation of Aqueous Liquid Composition

Using the polymer particle dispersion liquids 1 to 5 prepared by the above-described materials and methods, 10 kinds of aqueous liquid compositions 1 to 10 were prepared with the material composition shown in Table 2. Each aqueous liquid composition was prepared by placing the materials shown in Table 2 in a container, stirring and mixing the same within magnetic stirrer for 2 hours, and then filtering the mixture with a membrane filter with a pore size of 5 μm to remove impurities, such as wastes and coarse particles. The numerical values in Table 2 were all % by mass, and ion exchanged water was added so that the total amount of the aqueous liquid composition was 100% by mass.

### 3.1.7 Preparation of Resin Dispersed Pigment Dispersion Liquid

In aqueous ink composition sets 11, 12, and 17 to be used in the Examples and the Comparative examples, water insoluble pigments were used as a colorant. When the pigments were added to the aqueous ink compositions, resin dispersed pigments in which pigments were dispersed beforehand with a resin dispersing agent were used.

The pigment dispersion liquid was prepared as follows. First, 7.5 parts by mass of acrylic acid-acrylic acid ester copolymer (Weight average molecular weight: 25,000, Acid value: 180) was added as a resin dispersing agent to 76 parts by mass of ion exchanged water, in which 1.5 parts by mass of 30% aqueous ammonia solution (neutralizer) was dissolved for dissolution. 15 parts by mass of each of the following pigments was added thereto, and then the mixture was dispersed in a ball mill with zirconia beads for 10 hours. Thereafter, centrifugal filtration by a centrifuge Was performed to remove impurities, such as coarse particles or waster, and the pigment concentration was adjusted to be 15% by mass. The pigment type used in manufacturing the pigment dispersion liquid is shown below.
C.I. Pigment Black 7 (Used for a resin dispersed black pigment dispersion liquid)
C.I. Pigment Yellow 74 (Used for a resin dispersed yellow, pigment dispersion liquid)
C.I. Pigment Red 122 (Used for a resin dispersed magenta pigment dispersion liquid)
C.I. Pigment Blue 15:3(Used for a resin dispersed cyan pigment dispersion liquid)
C.I. Pigment orange 43 (Used for a resin dispersed orange pigment dispersion liquid)
C.I. Pigment Green 36 (Used for a resin dispersed green pigment dispersion liquid)

### 3.1.8 Preparation of Aqueous Ink Composition Sets 11, 12, and 17

Using the resin dispersed pigment dispersion liquid prepared in “3.1.7 Preparation of Resin Dispersed Pigment Dispersion Liquid” above, aqueous ink compositions of 6 colors of black, yellow, magenta, cyan, orange, and green were prepared with the material composition shown in Table 2 to be used as aqueous ink composition sets 11, 12, and 17. Each ink composition was prepared by placing the materials shown in Table 2 in a container, stirring and mixing the same with a magnetic stirrer for 2 hours, and then filtering the mixture with a membrane filter with a pore size of 5 ml to remove impurities, such as wastes and coarse particles. The numerical values in Table 2 were all % by mass, and ion exchanged water was added so that the total ink amount was 100% by mass.

### 3.1.9 Preparation of Surface Treated Pigment Dispersion Liquid

For aqueous ink composition sets 13, 14, and 18 to be used in the Examples and the Comparative Examples, a surface treated pigment that was rendered dispersible in water by treating the pigment surface. When adding the same to the aqueous ink composition, a pigment dispersion liquid in which the surface treated pigment was dispersed in water was used. Then, a pigment dispersion liquid to be used was manufactured before the evaluation shown-below. The pigment dispersion liquid was obtained by mixing 15 parts by mass of each of the following pigments with 250 parts by mass of sulfolane, dispersing the mixture in a ball mill with zirconia beads for 1 hour, and then heating the obtained mixed liquid of a pigment paste and a solvent at 120° C. while reducing the pressure decompressing to distill off the moisture contained in the system. Subsequently, the inside of the system was heated to 150° C., 25 parts by mass of sulfur trioxide was added to be reacted for 6 hours, the resultant mixture was washed several times with a large amount of sulfolane, and then the mixture was poured in water for dispersion treatment. Thereafter, centrifugal filtration with a centrifuge was performed to remove impurities, such as coarse particles and wastes, and the pigment concentration was adjusted to be 15% by mass. The pigment type used in manufacturing the pigment dispersion liquids is shown below.
C.I. Pigment black 7 (Used for surface treated black pigment dispersion liquid)
C.I. Pigment Yellow 74 (Used for surface treated yellow pigment dispersion liquid)
C.I. Pigment Red 122 (Used for surface treated magenta pigment dispersion liquid)
C.I. Pigment Blue 15:3 (Used for surface treated cyan pigment dispersion liquid)
C.I. Pigment Orange 43 (Used for surface treated orange pigment dispersion liquid)
C.I. Pigment Green 36 (Used for surface treated green pigment dispersion liquid)

### 3.1.10 Preparation of Aqueous Ink Composition Sets 13, 14, and 18

Using the surface treated pigment dispersion liquids prepared in “3.1.7 Preparation of Resin Dispersed Pigment Dispersion Liquid” above, aqueous ink compositions of 6 colors of black, yellow, magenta, cyan, orange, and green were prepared with the material composition shown in Table 2 to be used as aqueous ink composition sets 13, 14, and 18. Each ink composition was prepared by placing the materials shown in Table 2 in a container, stirring and mixing the same with a magnetic stirrer for 2 hours, and then filtering the mixture with a membrane filter with a pore size of 5 μm to remove impurities, such as wastes and coarse particles. The numerical values in Table 2 were all % by mass, and ion exchanged water was added so that the total ink amount was 100% by mass.

### 3.1.11 Preparation of Disperse Dye Liquid

For the aqueous ink composition sets 15, 16, and 19 to be used in the Examples and the Comparative Example, water insoluble disperse dyes were used as a colorant. When the disperse dyes were added to the aqueous ink compositions, disperse dye liquids were used.

The disperse dye liquid was prepared as follows. First, 20 parts by mass of naphthalene sulfonic acid formaldehyde condensate and 5 parts by mass of sodium lignin sulfonate were added to 57 parts by mass of ion exchanged water and then the mixture was stirred. Thereafter, 10 parts by mass of propylene glycol and 8 parts by mass of disperse dye were added, and the mixture was dispersed in a ball mill with zirconia beads for 1 hour. Thereafter, filtration was performed to remove impurities, such as coarse particles and wastes, and sodium hydroxide and ion exchanged water were added in such a manner as to adjust the pH to 7 and the dye concentration to 15% by mass. The type of the disperse dyes used in manufacturing the disperse dye liquids is shown below.
C.I. Disperse black 39 (Used for black disperse dye liquid)
C.I. Disperse yellow 64 (Used for yellow disperse dye liquid)
C.I. Disperse Red 60 (Used for magenta disperse dye liquid)
C.I. Disperse Blue 79:1 (Used for cyan disperse dye liquid)
C.I. Disperse Orange 8 (Used for orange disperse dye liquid)
C.I. Disperse Green 9 (Used for green disperse dye liquid)

### 3.1.12 Preparation of Aqueous Ink Composition Sets 15, 16, and 19

Using the disperse dye liquids prepared in “3.1.11 Preparation of Disperse Dye Liquid” above, aqueous ink compositions of 6 colors of black, yellow, magenta, cyan, orange, and green were prepared with the material composition shown in Table 2 to be used as aqueous ink composition sets 15, 16, and 19. Each ink composition was prepared by placing the materials shown in Table 2 in a container, stirring and mixing the same with a magnetic stirrer for 2 hours, and then filtering the mixture with a membrane filter with a pore size of 5 μm to remove impurities, such as wastes and coarse particles. The numerical values in Table 2 were all % by mass, and ion exchanged water was added so that the total ink amount was 100% by mass.

TABLE 2

| | Aqueous liquid composition | | | | | | | | | |
|---|---|---|---|---|---|---|---|---|---|---|
| | Examples | | | | | Comparative Examples | | | | |
| Material | 1 | 2 | 3 | 4 | 5 | 6 | 7 | 8 | 9 | 10 |
| Resin dispersed pigment dispersion liquid | — | — | — | — | — | — | — | — | — | — |
| Surface treated resin dispersion liquid | — | — | — | — | — | — | — | — | — | — |
| Disperse dye liquid | — | — | — | — | — | — | — | — | — | — |
| Polymer particle dispersion liquid 1 | 20 | — | — | — | — | 20 | — | — | — | — |
| Polymer particle dispersion liquid 2 | — | 20 | — | — | — | — | 20 | — | — | — |
| Polymer particle dispersion liquid 3 | — | — | 20 | — | — | — | — | 20 | — | — |
| Polymer particle dispersion liquid 4 | — | — | — | 20 | — | — | — | — | 20 | — |
| Polymer particle dispersion liquid 5 | — | — | — | — | 20 | — | — | — | — | 20 |
| Polyethylene wax emulsion <35% dispersion | 3 | 3 | 3 | 3 | 3 | — | 3 | 3 | 3 | 3 |
| liquid> (wax particles) | | | | | | | | | | |
| Tripropylene glycol monomethyl ether | 3 | — | — | — | — | 3 | — | — | — | — |
| (glycol ethers, HLB value: 8.0) | | | | | | | | | | |
| Triethylene glycol monohexyl ether | — | 6 | — | — | 6 | — | 6 | — | — | — |
| (glycol ethers, HLB value: 7.0) | | | | | | | | | | |
| Ethylene glycol mono-2-ethylhexyl | — | — | 2 | — | — | — | — | — | — | — |
| ether (glycol ethers, HLB value: 5.4) | | | | | | | | | | |
| Diethylene glycol mono-2-ethylhexyl | — | — | — | 0.1 | — | — | — | — | — | — |
| ether (glycol ethers, HLB value: 5.8) | | | | | | | | | | |
| Triethylene glycol monobutyl ether | — | — | — | — | — | — | — | — | 0.1 | — |
| (glycol ethers, HLB value: 8.5) | | | | | | | | | | |
| Diethylene glycol monododecyl | — | — | — | — | — | — | — | — | — | 6 |
| ether (glycol ethers, HLB value: 3.8) | | | | | | | | | | |
| 1,2-hexane diol (1,2-alkyl diols) | 4 | 3 | 6 | 0.5 | 3 | 4 | — | 6 | 0.5 | 3 |
| Polyvinyl pyrrolidone K-15 (pyrrolidone resin | 1 | — | — | 1 | — | 1 | — | — | 1 | — |
| derivative) | | | | | | | | | | |
| 2-pyrrolidone (pyrrolidone derivative) | 5 | 6 | 5 | 2 | 2 | 5 | 6 | 5 | 2 | 2 |
| Propylene glycol (polyhydric alcohols) | 5 | 3 | 5 | 12 | 8 | 5 | 3 | 5 | 12 | 8 |
| BYK-348 (silicone surfactant) | 1 | — | 0.5 | 0.5 | 1.5 | 1 | — | 0.5 | 0.5 | 1.5 |
| Surfinol DF110D (acetylene glycol surfactant) | — | — | — | 0.2 | — | — | — | — | 0.2 | — |
| Olfine E1010 (acetylene glycol surfactant) | 0.5 | — | — | — | — | 0.5 | — | — | — | — |
| Styrene-acrylic acid copolymer emulsion dispersion | — | — | — | — | — | — | — | — | — | — |
| liquid (Tg: 50° C., 50% dispersion liquid) | | | | | | | | | | |
| Triisopropanolamine (pH adjuster) | 0.1 | 0.1 | 0.1 | 0.1 | 0.1 | 0.1 | 0.1 | 0.1 | 0.1 | 0.1 |
| Ethylenediaminetetraacetic acid (chelating agent) | 0.05 | 0.05 | 0.05 | 0.05 | 0.05 | 0.05 | 0.05 | 0.05 | 0.05 | 0.05 |
| Benzotriazole (anti-rust agent) | 0.02 | 0.02 | 0.02 | 0.02 | 0.02 | 0.02 | 0.02 | 0.02 | 0.02 | 0.02 |
| Ion-exchanged water | Balance | Balance | Balance | Balance | Balance | Balance | Balance | Balance | Balance | Balance |

| | Aqueous ink composition set | | | | | | | | |
|---|---|---|---|---|---|---|---|---|---|
| | Examples | | | | | | Comparative Examples | | |
| Material | 11 | 12 | 13 | 14 | 15 | 16 | 17 | 18 | 19 |
| Resin dispersed pigment dispersion liquid | 30 | 30 | — | — | — | — | 30 | — | — |
| Surface treated resin dispersion liquid | — | — | 30 | 30 | — | — | — | 30 | — |
| Disperse dye liquid | — | — | — | — | 30 | 30 | — | — | 30 |
| Polymer particle dispersion liquid 1 | — | — | — | — | — | — | — | — | — |
| Polymer particle dispersion liquid 2 | — | — | — | — | — | — | — | — | — |
| Polymer particle dispersion liquid 3 | — | — | — | — | — | — | — | — | — |
| Polymer particle dispersion liquid 4 | — | — | — | — | — | — | — | — | — |
| Polymer particle dispersion liquid 5 | — | — | — | — | — | — | — | — | — |
| Polyethylene wax emulsion <35% dispersion | — | 0.5 | — | 0.5 | — | 0.5 | — | — | — |
| liquid> (wax particles) | | | | | | | | | |
| Tripropylene glycol monomethyl ether (glycol ethers, | 3 | — | 3 | — | 3 | — | — | — | — |
| HLB value: 8.0) | | | | | | | | | |
| Triethylene glycol monohexyl ether (glycol ethers, | — | — | — | — | — | — | — | — | — |
| HLB value: 7.0) | | | | | | | | | |
| Ethylene glycol mono-2-ethylhexyl ether (glycol ethers, | — | 1 | — | 1 | — | 1 | — | — | — |
| HLB value: 5.4) | | | | | | | | | |
| Diethylene glycol mono-2-ethylhexyl ether (glycol ethers, HLB | — | — | — | — | — | — | — | — | — |
| value: 5.8) | | | | | | | | | |
| Triethylene glycol monobutyl ether (glycol ethers, HLB | — | — | — | — | — | — | — | — | — |
| value: 8.5) | | | | | | | | | |
| Diethylene glycol monododecyl ether | — | — | — | — | — | — | — | — | — |
| (glycol ethers, HLB value: 3.8) | | | | | | | | | |
| 1,2-hexane diol (1,2-alkyl diols) | 8 | 4 | 8 | 4 | 8 | 4 | 8 | 8 | 8 |
| Polyvinyl pyrrolidone K-15 (pyrrolidone resin derivative) | — | 1 | — | 1 | — | 1 | — | — | — |
| 2-pyrrolidone (pyrrolidone derivative) | — | 4 | — | 4 | — | 4 | — | — | — |
| Propylene glycol (polyhydric alcohols) | — | 10 | — | 10 | — | 10 | — | — | — |
| BYK-348 (silicone surfactant) | — | 0.5 | — | 0.5 | — | 0.5 | — | — | — |
| Surfinol DF110D (acetylene glycol surfactant) | — | 0.2 | — | 0.2 | — | 0.2 | — | — | — |
| Olfine E1010 (acetylene glycol surfactant) | — | — | — | — | — | — | — | — | — |
| Styrene-acrylic acid copolymer emulsion dispersion liquid | — | 1 | — | 1 | — | 1 | — | — | — |
| (Tg: 50° C., 50% dispersion liquid) | | | | | | | | | |
| Triisopropanolamine (pH adjuster) | 0.1 | 0.1 | 0.1 | 0.1 | 0.1 | 0.1 | 0.1 | 0.1 | 0.1 |
| Ethylenediaminetetraacetic acid (chelating agent) | 0.05 | 0.05 | 0.05 | 0.05 | 0.05 | 0.05 | 0.05 | 0.05 | 0.05 |
| Benzotriazole (anti-rust agent) | 0.02 | 0.02 | 0.02 | 0.02 | 0.02 | 0.02 | 0.02 | 0.02 | 0.02 |
| Ion-exchanged water | Balance | Balance | Balance | Balance | Balance | Balance | Balance | Balance | Balance |

In Table 2, “BYK-348” used as a silicone surfactant is a trade name and is manufactured by BYK-Chemie Japan. K.K. “Surfinol DF110D” and “Olfine E1010” used as an acetylene glycol surfactant are trade names and are manufactured by Nisshin Chemical Co., Ltd. “Polyvinyl pyrrolidone K-15” used as a pyrrolidone resin derivative is a trade name and is manufactured by Tokyo Kasai Kogyo Co., Ltd.

### 3.2 Evaluation of Printed Material

### 3.2.1 Abrasion Resistance Evaluation

Used as a recording medium were a cold laminate film PG-50L (trade name, manufactured by LAMI CORPORATION, INC.) which is a non-ink absorbing polyethylene terephthalate film, a cold laminate film PPM-25 (trade name, manufactured by LAMI CORPORATION, INC.) which is a non-ink absorbing polypropylene film, and L round OPP60W.PA-T1E.8K (trade name, manufactured by LINTEC Corp.).

Used as a printer was PX-G930 (trade name, Seiko Epson Corporation, Nozzle row: 8 rows (which allows simultaneous printing of 8 kinds of inks), Nozzle resolution: 180 dpi) which is an ink let printer having a system of jetting and recording ink droplets by a piezoelectric element. In the Examples, a temperature variable heater was attached to a paper guide portion of the printer in such a manner as to heat a recording medium under printing from the back surface thereof. The heater of the printer was set so that the temperature of the printing surface was 40° C., and the evaluation was carried out in a laboratory in which the temperature was adjusted to room temperature (25° C.)

The evaluation was carried out in the following procedure.

First, 6 nozzle rows of the 8 nozzle rows of the ink jet printer PX-G930 were charged with any one set (6 colors) of the aqueous ink composition sets 11 to 19 and the remaining 2 nozzle rows of the nozzle rows were charged with any one kind of the aqueous liquid compositions 1 to 10.

The heater of the paper guide portion was set so that “the temperature of the printing surface was 40° C”, and then it was confirmed that the temperature inside the paper guide portion was stabilized. Thereafter, a solid pattern having a resolution of 360 dpi×360 dpi was first printed on the recording media using only the aqueous ink composition sets charged in the 6 nozzle rows.

Subsequently, the printed recording media discharged from the printer were set again to the ink jet printer, a solid pattern over the entire surface of the recording media (in a manner of covering the solid pattern printed with the ink sets) was printed only with the aqueous liquid compositions to the printed surface of the recording media using the remaining 2 nozzle rows. Then, the printed surface of the discharged recording media immediately after printing was dried as it was (no air) or air having a temperature of any one of 25° C. (room temperature), 40° C., 80° C., or 100° C. was applied to the printed surface for drying so that the air applying rate was about 6 m/second. When applying the air, the air applying time was 1 minute.

Thereafter, the printed surface of the printed materials that were allowed to stand for 5 hours in the laboratory under the room temperature (25° C.) condition was rubbed using cotton 10 times under a load of 500 g, and then the separation state of the printed surface or the ink transfer to the cotton was confirmed using a color fastness rubbing tester AB-301 (trade name, manufactured by TESTER SANGYO CO., LTD.) to evaluate the abrasion resistance. The evaluation criteria of the abrasion resistance are as follows.
A: No ink separation and ink transfer to the cotton occurred even after rubbing 10 times.
B: No ink separation occurred but ink transfer to the cotton slightly occurred after rubbing 10 times.
C: No ink separation occurred but ink transfer to the cotton somewhat occurred after rubbing 10 times.
D: Ink separation and ink transfer to the cotton occurred after rubbing 10 times.
E: Ink separation and ink transfer to the cotton occurred after rubbing 1 to 9 times.

Table 3 shows the abrasion resistance evaluation results when printing was carried out to the cold laminate film PG-50L (trade name, manufactured by LAMI CORPORATION, INC.) which is a non-ink absorbing polyethylene terephthalate film. Table 4 shows the abrasion resistance evaluation results when printing was carried cut to the cold laminate film PPM-25 (trade name, manufactured by LAMI CORPORATION, INC.) which is similarly a non-ink absorbing polypropylene film. Table 5 shows the abrasion resistance evaluation results when printing was carried out to the L round OPP60WPA-T1E-8K (trade name, manufactured by LINTEC Corp.) which is similarly a non-ink absorbing polypropylene film.

TABLE 3
Abrasion resistance evaluation results of cold laminate film PG-50L

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | D | D | C | D | C | E | E | E | E | E | E |
| | | 12 | C | C | C | C | C | E | D | E | D | D | E |
| | | 13 | D | D | D | D | D | E | E | E | E | E | E |
| | | 14 | C | C | C | C | C | E | E | E | D | D | E |
| | | 15 | D | D | D | D | D | E | E | E | E | E | E |
| | | 16 | C | C | C | C | C | E | E | E | E | E | E |
| | Comparative | 17 | D | D | D | E | D | E | E | E | E | E | E |
| | Examples | 18 | D | D | E | E | E | E | E | E | E | E | E |
| | | 19 | D | D | E | E | E | E | E | E | E | E | E |
| Room | Examples | 11 | C | C | B | C | B | E | E | D | D | D | E |
| temperature | | 12 | B | B | B | B | B | D | C | D | C | C | D |
| (25° C.) | | 13 | C | C | C | C | C | E | E | E | E | E | E |
| | | 14 | B | B | B | B | B | D | D | D | C | C | E |
| | | 15 | C | C | C | C | C | E | E | E | E | E | E |
| | | 16 | B | B | B | B | B | D | D | D | D | D | E |
| | Comparative | 17 | C | C | C | D | C | E | E | E | E | E | E |
| | Examples | 18 | C | C | D | D | D | E | E | E | E | E | E |
| | | 19 | C | C | D | D | D | E | E | E | E | E | E |
| 40° C. | Examples | 11 | C | C | A | B | B | E | D | D | C | D | E |
| | | 12 | A | A | A | A | A | D | C | C | C | C | C |
| | | 13 | C | C | A | B | C | E | E | D | D | D | E |
| | | 14 | B | B | A | B | B | D | D | D | C | C | D |
| | | 15 | C | C | B | B | C | E | E | E | D | E | E |
| | | 16 | B | B | B | B | B | D | D | D | C | D | D |
| | Comparative | 17 | C | C | B | C | C | E | E | E | E | E | E |
| | Examples | 18 | C | C | C | C | C | E | E | E | E | E | E |
| | | 19 | C | C | C | D | C | E | E | E | E | E | E |
| 60° C. | Examples | 11 | A | B | A | A | A | D | D | D | C | D | E |
| | | 12 | A | A | A | A | A | C | C | C | C | C | C |
| | | 13 | B | C | A | A | A | E | E | D | D | D | E |
| | | 14 | A | B | A | A | A | D | D | C | C | C | D |
| | | 15 | B | C | A | B | B | E | E | E | D | D | E |
| | | 16 | A | A | A | A | A | D | D | D | C | C | D |
| | Comparative | 17 | C | C | B | B | B | D | E | E | E | E | E |
| | Examples | 18 | C | C | B | C | B | E | E | E | E | E | E |
| | | 19 | C | C | C | C | C | E | E | E | E | E | E |
| 80° C. | Examples | 11 | A | A | A | A | A | D | D | D | C | D | D |
| | | 12 | A | A | A | A | A | C | C | C | B | C | C |
| | | 13 | A | A | A | A | A | D | D | D | C | D | E |
| | | 14 | A | A | A | A | A | C | C | C | C | C | D |
| | | 15 | A | B | A | A | A | E | E | D | D | D | E |
| | | 16 | A | A | A | A | A | D | D | C | C | C | D |
| | Comparative | 17 | B | B | B | B | B | D | E | E | E | E | E |
| | Examples | 18 | B | C | B | C | B | D | E | E | E | E | E |
| | | 19 | B | C | B | C | B | D | E | E | E | E | E |

TABLE 4
Abrasion resistance evaluation results of cold laminate film PPM-25

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | D | D | D | D | C | E | E | E | E | E | E |
| | | 12 | C | C | C | C | B | E | E | E | E | E | E |
| | | 13 | D | D | D | D | D | E | E | E | E | E | E |
| | | 14 | C | C | C | C | C | E | E | E | E | E | E |
| | | 15 | D | D | D | D | D | E | E | E | E | E | E |
| | | 16 | C | C | C | C | C | E | E | E | E | E | E |
| | Comparative | 17 | E | E | E | E | D | E | E | E | E | E | E |
| | Examples | 18 | E | E | E | E | E | E | E | E | E | E | E |
| | | 19 | E | E | E | E | E | E | E | E | E | E | E |
| Room | Examples | 11 | C | C | C | C | C | E | E | E | E | E | E |
| temperature | | 12 | B | B | B | B | B | D | D | D | D | D | D |
| (25° C.) | | 13 | C | C | C | C | C | E | E | E | E | E | E |
| | | 14 | B | B | B | B | B | D | D | D | D | D | E |
| | | 15 | C | C | C | C | C | E | E | E | E | E | E |
| | | 16 | B | B | B | B | B | D | D | D | D | D | E |
| | Comparative | 17 | D | D | D | D | C | E | E | E | E | E | E |
| | Examples | 18 | D | D | D | D | D | E | E | E | E | E | E |
| | | 19 | D | D | D | D | D | E | E | E | E | E | E |
| 40° C. | Examples | 11 | C | C | A | B | B | E | E | D | D | D | E |
| | | 12 | B | B | A | A | A | D | D | C | C | C | D |
| | | 13 | C | C | B | B | C | E | E | E | E | D | E |
| | | 14 | B | B | A | A | B | D | D | D | D | C | D |
| | | 15 | C | C | B | C | C | E | E | E | E | E | E |
| | | 16 | B | B | A | B | B | D | D | D | D | D | D |
| | Comparative | 17 | D | D | C | C | C | E | E | E | E | E | E |
| | Examples | 18 | D | D | C | D | D | E | E | E | E | E | E |
| | | 19 | D | D | D | D | D | E | E | E | E | E | E |
| 60° C. | Examples | 11 | A | C | A | A | A | D | E | D | D | D | E |
| | | 12 | A | B | A | A | A | C | D | C | C | C | D |
| | | 13 | B | C | A | B | A | E | E | E | E | D | E |
| | | 14 | A | B | A | A | A | D | D | D | D | C | D |
| | | 15 | B | C | B | C | B | E | E | E | E | D | E |
| | | 16 | A | B | A | B | A | D | D | D | D | C | D |
| | Comparative | 17 | C | C | B | B | B | E | E | E | E | E | E |
| | Examples | 18 | C | C | B | C | C | E | E | E | E | E | E |
| | | 19 | C | D | B | C | C | E | E | E | E | E | E |
| 80° C. | Examples | 11 | A | A | A | A | A | D | D | D | D | D | D |
| | | 12 | A | A | A | A | A | C | C | C | C | C | C |
| | | 13 | A | B | A | A | A | D | E | D | D | D | E |
| | | 14 | A | A | A | A | A | C | D | C | C | C | D |
| | | 15 | A | C | A | A | B | D | E | E | E | D | E |
| | | 16 | A | B | A | A | A | C | D | D | D | C | D |
| | Comparative | 17 | B | B | B | B | B | D | D | E | E | E | E |
| | Examples | 18 | B | B | B | B | B | D | E | E | E | E | E |
| | | 19 | B | C | B | B | B | E | E | E | E | E | E |

TABLE 5
Abrasion resistance evaluation results of L round OPP60W·PA-T1E·8K

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | D | D | D | D | D | E | E | E | E | E | E |
| | | 12 | C | C | C | C | B | E | E | E | E | E | E |
| | | 13 | D | D | D | D | D | E | E | E | E | E | E |
| | | 14 | C | C | C | C | C | E | E | E | E | E | E |
| | | 15 | D | D | D | D | D | E | E | E | E | E | E |
| | | 16 | C | C | C | C | C | E | E | E | E | E | E |
| | Comparative | 17 | E | E | E | E | E | E | E | E | E | E | E |
| | Examples | 18 | E | E | E | E | E | E | E | E | E | E | E |
| | | 19 | E | E | E | E | E | E | E | E | E | E | E |
| Room | Examples | 11 | C | C | C | C | C | E | E | E | E | E | E |
| temperature | | 12 | B | B | B | B | B | D | D | D | D | D | D |
| (25° C.) | | 13 | C | C | C | C | C | E | E | E | E | E | E |
| | | 14 | B | B | B | B | B | D | D | D | D | D | E |
| | | 15 | C | C | C | C | C | E | E | E | E | E | E |
| | | 16 | B | B | B | B | B | D | D | D | D | D | E |
| | Comparative | 17 | D | D | D | D | D | E | E | E | E | E | E |
| | Examples | 18 | D | D | D | D | D | E | E | E | E | E | E |
| | | 19 | D | D | D | D | D | E | E | E | E | E | E |
| 40° C. | Examples | 11 | C | C | A | B | B | E | E | D | D | D | E |
| | | 12 | B | B | A | A | A | D | D | C | C | C | D |
| | | 13 | C | C | A | B | C | E | E | E | E | D | E |
| | | 14 | B | B | A | A | B | D | D | D | D | C | D |
| | | 15 | C | C | B | B | C | E | E | E | E | E | E |
| | | 16 | B | B | A | A | B | D | D | D | D | D | D |
| | Comparative | 17 | D | D | B | C | C | E | E | E | E | E | E |
| | Examples | 18 | D | D | B | C | D | E | E | E | E | E | E |
| | | 19 | D | D | C | C | D | E | E | E | E | E | E |
| 60° C. | Examples | 11 | A | B | A | A | B | D | D | D | D | D | E |
| | | 12 | A | A | A | A | A | C | C | C | C | C | C |
| | | 13 | B | C | A | A | B | E | E | D | E | D | E |
| | | 14 | A | B | A | A | A | D | D | C | D | C | D |
| | | 15 | B | C | A | B | B | E | E | E | E | D | E |
| | | 16 | A | B | A | A | A | D | D | D | D | C | D |
| | Comparative | 17 | B | C | B | B | C | E | E | E | E | E | E |
| | Examples | 18 | C | D | B | B | C | E | E | E | E | E | E |
| | | 19 | C | D | B | C | C | E | E | E | E | E | E |
| 80° C. | Examples | 11 | — | — | — | — | — | — | — | — | — | — | — |
| | | 12 | — | — | — | — | — | — | — | — | — | — | — |
| | | 13 | — | — | — | — | — | — | — | — | — | — | — |
| | | 14 | — | — | — | — | — | — | — | — | — | — | — |
| | | 15 | — | — | — | — | — | — | — | — | — | — | — |
| | | 16 | — | — | — | — | — | — | — | — | — | — | — |
| | Comparative | 17 | — | — | — | — | — | — | — | — | — | — | — |
| | Examples | 18 | — | — | — | — | — | — | — | — | — | — | — |
| | | 19 | — | — | — | — | — | — | — | — | — | — | — |

As shown in Tables 3 to 5, when printing was performed by combining the aqueous liquid compositions 1 to 5 and the aqueous ink composition sets 11 to 16 that have compositions usable in the printing method according to an embodiment of the invention, printed materials having favorable abrasion resistance were obtained. When passing through preferable conditions (heating temperature and the like) in the drying process, printed materials with more favorable abrasion resistance were obtained. Furthermore, with respect to the aqueous ink composition set 12, the aqueous ink composition set 14, and the aqueous ink composition set 16 to which polymer particles and wax particles that can be preferably used in the aqueous ink composition were added, the abrasion resistance of the printed materials using the same further increased. In contrast, in the case of using the aqueous liquid compositions 6 to 10 of Comparative Examples (having unsuitable compositions for use in the printing method according to an embodiment of the invention) as the aqueous liquid composition or using no aqueous liquid compositions, printed materials having poor abrasion resistance were obtained. In the case of the aqueous ink composition sets 17 to 19 of Comparative Examples (having unsuitable compositions for use in the printing method according to an embodiment of the invention), printed materials having poorer abrasion resistance were obtained.

When air having a temperature of 100° C. was applied to the printed surface of the recording medium as the drying process, all the media of “cold laminate film PG-50L”, “cold laminate film. PPM-25”, and “L round OPP60W.PA-T1E.8K” were distorted and deformed due to heat. When air having a temperature of 80° C. was applied to the printed surface of the recording medium as the drying process, only the “L round OPP60W.PA-T1E-8K” was distorted and deformed due to heat. The media that were distorted and deformed due to heat were not able to be set in a color fastness rubbing tester AB-301, and thus were not able to evaluate the abrasion resistance. Therefore, in Tables 3 to 5, the results of the hot air setting of “100° C.” were not shown and the results of the hot air setting of “80° C.” of Table 5 were indicated as “−”.

Here, it is presumed that since the “L round OPP60W.PA-T1E.8K” is a medium for labels having a three-layer structure of a polypropylene film which is a surface base material, an adhesive, and a release paper, the thermal expansion coefficients are different from each other between the polypropylene film and the release paper, and thus a gap is formed between the materials due to heat during the drying process, and therefore the “L round OPP60W.PA-T1E.8K” was deformed with a heating temperature (80° C.) lower than that of other media.

### 3.2.2 Evaluation of Bleeding of Printed Material

Used as a recording medium were a cold laminate film PG-50L (trade name, manufactured by LAMI CORPORATION, INC.) which is a non-ink absorbing polyethylene terephthalate film, a cold laminate film-PPM-25 (trade name, manufactured by LAMI CORPORATION, INC.) which is a non-ink absorbing polypropylene film, and L round OPP60W.PA-T1E.8K (trade name, manufactured by LINTEC Corp.

Used as an ink jet recording printer was PX-G930 (trade name, manufactured by Seiko Epson Corporation, Nozzle row: 8 rows (which allows of simultaneous printing of 8 kinds of inks), Nozzle resolution: 180 dpi) which is an ink jet printer having a system of jetting and recording ink droplets by a piezoelectric element. In the Examples, a temperature variable heater was attached to a paper guide portion of the printer in such a manner as to heat a recording medium under printing from the back surface thereof. The evaluation was carried out in a laboratory in which the temperature was adjusted to room temperature (25° C.)

The evaluation was carried out in the following procedure.

First, 6 nozzle rows of the 8 nozzle rows of the ink jet printer PX-G930 were charged with any one set (6 colors) of the aqueous ink composition sets 11 to 19 and the remaining 2 nozzle rows of the nozzle rows were charged with any one kind of the aqueous liquid compositions 1 to 10. Then, the heater of the paper guide portion was set so that “the temperature of the printing surface was 40° C”, and then it was confirmed that the temperature inside the paper guide portion was stabilized. Thereafter, a solid pattern having a resolution of 360 dpi×360 dpi and being capable of printing with a duty in the range of 50 to 100% by 10% in such a manner that different color inks were in contact with each other or were laminated was first printed on the recording media using only the aqueous ink composition sets charged in the 6 nozzle rows. Subsequently, the printed recording media discharged from the printer were set again to the ink jet printer, a solid pattern over the entire surface of the recording media (in a manner of covering the solid pattern printed with the ink sets) was printed only with the aqueous liquid compositions on the printed surface of the recording media using the remaining 2 nozzle rows. Then, the printed materials during printing and immediately after printing were dried as they were (no air) or air having a temperature of any one of 25° C. (room temperature), 40° C., 60° C., or 80° C. was applied thereto so that the air applying rate on the recording medium surface was about 6 m/second, and thus drying treatment was carried out. The air applying time immediately after printing was 1 minute.

The bleeding in the single color and multicolor printed materials when printed under such conditions was visually confirmed. The results are shown in Table 5. The evaluation criteria of bleeding of the printed materials are as follows.
A: No bleeding was observed even when the duty was 80% or more.
B: No bleeding was observed even until the duty reached 70%.
C: No bleeding was observed even until the duty reached 60%.
D: Bleeding was observed even when the duty was 60% or lower.

Table 6 shows the bleeding evaluation results when printing was carried out to the cold laminate film PG-50L (trade name, manufactured by LAMI CORPORATION, INC.) which is a non-ink absorbing polyethylene terephthalate film. Table 7 shows the bleeding evaluation results when printing was carried out to the cold laminate film PPM-25 (trade name, manufactured by LANI CORPORATION, INC.) which is similarly a non-ink absorbing polypropylene film. Table 8 shows the bleeding evaluation results when printing was carried out to the L round OPP60W.PA-T1E.8K (trade name, manufactured by LINTEC Corp.) which is similarly a non-ink absorbing polypropylene film.

TABLE 6
Evaluation results of bleeding on cold laminate film PG-50L

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | C | C | C | C | C | C | D | D | D | C | C |
| | | 12 | A | A | A | A | A | A | C | C | C | A | A |
| | | 13 | C | C | C | C | C | C | D | D | D | C | C |
| | | 14 | A | A | A | A | A | A | C | C | C | A | A |
| | | 15 | C | C | C | C | C | C | D | D | D | C | C |
| | | 16 | B | B | B | B | B | B | C | C | C | B | B |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| Room | Examples | 11 | B | B | B | B | B | B | C | C | C | B | B |
| temperature | | 12 | A | A | A | A | A | A | B | B | B | A | A |
| (25° C.) | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| 40° C. | Examples | 11 | B | B | B | B | B | B | C | C | C | B | B |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 60° C. | Examples | 11 | A | A | A | B | A | B | C | C | C | B | A |
| | | 12 | A | A | A | A | A | A | B | B | B | A | A |
| | | 13 | B | A | A | B | A | B | C | C | C | B | A |
| | | 14 | A | A | A | A | A | A | B | B | B | A | A |
| | | 15 | B | B | A | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 80° C. | Examples | 11 | A | A | A | A | A | B | C | C | C | B | A |
| | | 12 | A | A | A | A | A | A | B | B | B | A | A |
| | | 13 | A | A | A | B | A | B | C | C | C | B | A |
| | | 14 | A | A | A | A | A | A | B | B | B | A | A |
| | | 15 | B | A | A | B | A | B | C | C | C | B | A |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |

TABLE 7
Evaluation results of bleeding on cold laminate film PPM-25

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | C | C | C | C | C | C | D | D | D | C | C |
| | | 12 | A | A | A | A | A | A | C | C | C | A | A |
| | | 13 | C | C | C | C | C | C | D | D | D | C | C |
| | | 14 | A | A | A | A | A | A | C | C | C | A | A |
| | | 15 | C | C | C | C | C | C | D | D | D | C | C |
| | | 16 | B | B | B | B | B | B | C | C | C | B | B |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| Room | Examples | 11 | B | B | B | B | B | B | C | C | C | B | B |
| temperature | | 12 | A | A | A | A | A | A | B | B | B | A | A |
| (25° C.) | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| 40° C. | Examples | 11 | B | B | B | B | B | B | C | C | C | B | B |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 60° C. | Examples | 11 | B | A | A | B | A | B | C | C | C | B | A |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 80° C. | Examples | 11 | A | A | A | B | A | B | C | C | C | B | A |
| | | 12 | A | A | A | A | A | A | B | B | B | A | A |
| | | 13 | B | A | A | B | A | B | C | C | C | B | A |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |

TABLE 8
Evaluation results of bleeding on L round OPP60W·PA-T1E·8K

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | C | C | C | C | C | C | D | D | D | C | C |
| | | 12 | A | A | A | A | A | A | C | C | C | A | A |
| | | 13 | C | C | C | C | C | C | D | D | D | C | C |
| | | 14 | A | A | A | A | A | A | C | C | C | A | A |
| | | 15 | C | C | C | C | C | C | D | D | D | C | C |
| | | 16 | B | B | B | B | B | B | C | C | C | B | B |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| Room | Examples | 11 | B | B | B | B | B | B | C | C | C | B | B |
| temperature | | 12 | A | A | A | A | A | A | B | B | B | A | A |
| (25° C.) | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| 40° C. | Examples | 11 | B | B | B | B | B | B | C | C | C | B | B |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 60° C. | Examples | 11 | B | A | A | B | A | B | C | C | C | B | A |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 80° C. | Examples | 11 | — | — | — | — | — | — | — | — | — | — | — |
| | | 12 | — | — | — | — | — | — | — | — | — | — | — |
| | | 13 | — | — | — | — | — | — | — | — | — | — | — |
| | | 14 | — | — | — | — | — | — | — | — | — | — | — |
| | | 15 | — | — | — | — | — | — | — | — | — | — | — |
| | | 16 | — | — | — | — | — | — | — | — | — | — | — |
| | Comparative | 17 | — | — | — | — | — | — | — | — | — | — | — |
| | Examples | 18 | — | — | — | — | — | — | — | — | — | — | — |
| | | 19 | — | — | — | — | — | — | — | — | — | — | — |

As shown in Tables 6 to 8, when printing was performed by combining the aqueous liquid compositions 1 to 5 and the aqueous ink composition sets 11 to 16 that have compositions usable in the printing method according to an embodiment of the invention, printed materials having less bleeding were obtained. When passing through preferable conditions (heating temperature and the like) in the drying process, printed materials with much less bleeding were obtained. With respect to the aqueous ink composition set 12, the aqueous ink composition set 14, and the aqueous ink composition set 16 to which polymer :articles and wax particles that can be preferably used in the aqueous ink composition were added, the bleeding of the printed materials using the same further decreased. In contrast, in the case of using the aqueous liquid compositions 6 to 10 of Comparative Examples (having unsuitable compositions for use in the printing method according to an embodiment of the invention) as the aqueous liquid composition or using no aqueous liquid composition, printed materials having a high degree of bleeding were obtained even when passing through the drying process. In the case of the aqueous ink composition sets 17 to 19 of Comparative Examples (having unsuitable compositions for use in the printing method according to an embodiment of the invention), unclear printed materials having a higher degree of bleeding were obtained.

When air having a temperature of 100° C. was applied to the printed surface of the recording media as the drying process, all the media of the “cold laminate film PG-50L”, “cold laminate film PPM-25”, and “L round OPP60W.PA-T1E.8K” were distorted and deformed due to heat. When air having a temperature of 80° C. was applied to the printed surface of the recording media as the drying process, only the “L round OPP60W.PA-T1E.8K” was distorted and deformed due to heat. The media that were distorted and deformed due to heat were not able to evaluate the bleeding. Therefore, in Tables 6 to 8, the results of the hot air setting of “100° C.” were not shown and the results of the hot air setting of “30° C.” of Table 8 were indicated as “−”.

### 3.2.3 Evaluation of Concentration Unevenness of Printed Material

Used as a recording medium were a cold laminate film PG-50L (trade name, manufactured by LAMI CORPORATION, INC.) which is a non-ink absorbing polyethylene terephthalate film, a cold laminate film PPM-25 (trade name, manufactured by LAMI CORPORATION, INC.) which is a non-ink absorbing polypropylene film, and L round OPP60W.PA-T1E.8K (trade name, manufactured by LINTEC Corp.).

Used as an ink jet recording printer was PX-G930 (trade name, Seiko Epson Corporation, Nozzle row: 8 rows (which allows simultaneous printing of 8 kinds of inks), Nozzle resolution: 180 dpi) which is an ink jet printer having a system of jetting and recording ink droplets by a piezoelectric element. In the Examples, a temperature variable heater was attached to a paper guide portion of the printer in such a manner as to heat a recording medium under printing from the back surface thereof. The evaluation was carried out in a laboratory in which the temperature was adjusted to room temperature (25° C.)

The evaluation was carried out in the following procedure.

First, 6 nozzle rows of the 8 nozzle rows of the ink jet printer PX-G930 were charged with any one set (6 colors) of the aqueous ink composition sets 11 to 19 and the remaining 2 nozzle rows of the nozzle rows were charged with any one kind of the aqueous liquid compositions 1 to 10. The heater of the paper guide portion was set so that “the temperature of the printing surface was 40° C”, and then it was confirmed that the temperature inside the paper guide portion was stabilized. Thereafter, a solid pattern having a resolution of 360 dpi×360 dpi and being capable of printing with a duty in the range of 50% to 100% by 10% was first printed on the recording media using only the aqueous ink composition sets charged in the 6 nozzle rows. Subsequently, the printed recording media discharged from the printer were set again to the ink jet printer, a solid pattern over the entire surface of the recording media (in a manner of covering the solid pattern printed with the ink set) was printed only with the aqueous liquid compositions on the printed surface of the recording media using the remaining 2 nozzle rows. Then, the printed materials during printing and immediately after printing were dried as they were (no air) or air having a temperature of any one of 25° C. (room temperature), 40° C., 60° C., or 80° C. was applied thereto so that the air applying rate on the recording medium surface was about 6 misecond, and thus drying treatment was carried out. The air applying time immediately after printing was 1 minute.

The concentration unevenness in the printed materials when printed under such conditions was visually confirmed. The results are shown in Table 6. The evaluation criteria of the concentration unevenness of the printed materials are as follows.
A: No concentration unevenness was observed even when the duty was 80% or more.
B: No concentration unevenness was observed even until the duty reached 70%.
C: No concentration unevenness was observed even until the duty reached 60%.
D: Concentration unevenness was observed even when the duty was 60% or lower.

Table 9 shows the concentration unevenness evaluation results when printing was carried out to the cold laminate film PG-50L (trade name, manufactured by LAMI CORPORATION, INC.) which is a non-ink absorbing polyethylene terephthalate film. Table 10 shows the concentration unevenness evaluation results when printing was carried out to the cold laminate film PPM-25 (trade name, manufactured by LAMI CORPORATION, INC.) which is similarly a non-ink absorbing polypropylene film. Table 11 shows the concentration unevenness evaluation results when printing was carried out to the L round OPP60W.PA-TIE.8K (trade name, manufactured by LINTEC Corp.) which is similarly a non-ink absorbing polypropylene film.

TABLE 9
Evaluation results of concentration unevenness on cold laminate film PG-50L

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | C | C | C | C | C | C | D | D | D | C | C |
| | | 12 | A | A | A | A | A | A | C | C | C | A | A |
| | | 13 | C | C | C | C | C | C | D | D | D | C | C |
| | | 14 | A | A | A | A | A | A | C | C | C | A | A |
| | | 15 | C | C | C | C | C | C | D | D | D | C | C |
| | | 16 | B | B | B | B | B | B | C | C | C | B | B |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| Room | Examples | 11 | B | B | B | B | B | B | C | C | C | B | B |
| temperature | | 12 | A | A | A | A | A | A | B | B | B | A | A |
| (25° C.) | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| 40° C. | Examples | 11 | B | B | B | B | B | B | C | C | C | B | B |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 60° C. | Examples | 11 | A | A | A | B | A | B | C | C | C | B | A |
| | | 12 | A | A | A | A | A | A | B | B | B | A | A |
| | | 13 | B | A | A | B | A | B | C | C | C | B | A |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 80° C. | Examples | 11 | A | A | A | A | A | B | C | C | C | B | A |
| | | 12 | A | A | A | A | A | A | B | B | B | A | A |
| | | 13 | A | A | A | B | A | B | C | C | C | B | A |
| | | 14 | A | A | A | A | A | A | B | B | B | A | A |
| | | 15 | B | A | A | B | A | B | C | C | C | B | A |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |

TABLE 10
Evaluation results of concentration unevenness on cold laminate film PPM-25

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | C | C | C | C | C | C | D | D | D | C | C |
| | | 12 | A | A | A | A | A | A | C | C | C | A | A |
| | | 13 | C | C | C | C | C | C | D | D | D | C | C |
| | | 14 | A | A | A | A | A | A | C | C | C | A | A |
| | | 15 | C | C | C | C | C | C | D | D | D | C | C |
| | | 16 | B | B | B | B | B | B | C | C | C | B | B |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| Room | Examples | 11 | B | B | B | B | B | B | C | C | C | B | B |
| temperature | | 12 | A | A | A | A | A | A | B | B | B | A | A |
| (25° C.) | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| 40° C. | Examples | 11 | B | B | B | B | B | B | C | C | C | B | B |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 60° C. | Examples | 11 | B | A | A | B | A | B | C | C | C | B | A |
| | | 12 | A | A | A | A | A | A | B | B | B | A | A |
| | | 13 | B | B | B | B | A | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 80° C. | Examples | 11 | A | A | A | B | A | B | C | C | C | B | A |
| | | 12 | A | A | A | A | A | A | B | B | B | A | A |
| | | 13 | B | A | A | B | A | B | C | C | C | B | A |
| | | 14 | A | A | A | A | A | A | B | B | B | A | A |
| | | 15 | B | B | B | B | A | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |

TABLE 11
Evaluation results of concentration unevenness on L round OPP60W·PA-T1E·8K

| Air | | | Aqueous liquid composition | | | | | | | | | | |
|---|---|---|---|---|---|---|---|---|---|---|---|---|---|
| application | Aqueous ink | | Examples | | | | | Comparative Examples | | | | | |
| setting | composition set | | 1 | 2 | 3 | 4 | 5 | 6 | 7 | 8 | 9 | 10 | No use |
| No air | Examples | 11 | C | C | C | C | C | C | D | D | D | C | C |
| | | 12 | A | A | A | A | A | A | C | C | C | A | A |
| | | 13 | C | C | C | C | C | C | D | D | D | C | C |
| | | 14 | A | A | A | A | A | A | C | C | C | A | A |
| | | 15 | C | C | C | C | C | C | D | D | D | C | C |
| | | 16 | B | B | B | B | B | B | C | C | C | B | B |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| Room | Examples | 11 | B | B | B | B | B | B | C | C | C | B | B |
| temperature | | 12 | A | A | A | A | A | A | B | B | B | A | A |
| (25° C.) | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | D | D | D | D | D | D | D | D | D | D | D |
| | Examples | 18 | D | D | D | D | D | D | D | D | D | D | D |
| | | 19 | D | D | D | D | D | D | D | D | D | D | D |
| 40° C. | Examples | 11 | B | B | B | B | B | B | C | C | C | B | B |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 60° C. | Examples | 11 | B | A | A | B | A | B | C | C | C | B | A |
| | | 12 | A | A | A | A | A | A | B | B | B | A | A |
| | | 13 | B | B | B | B | B | B | C | C | C | B | B |
| | | 14 | A | A | A | A | A | A | B | B | B | A | A |
| | | 15 | B | B | B | B | B | B | C | C | C | B | B |
| | | 16 | A | A | A | A | A | A | B | B | B | A | A |
| | Comparative | 17 | C | C | C | C | C | C | D | D | D | C | C |
| | Examples | 18 | C | C | C | C | C | C | D | D | D | C | C |
| | | 19 | C | C | C | C | C | C | D | D | D | C | C |
| 80° C. | Examples | 11 | — | — | — | — | — | — | — | — | — | — | — |
| | | 12 | — | — | — | — | — | — | — | — | — | — | — |
| | | 13 | — | — | — | — | — | — | — | — | — | — | — |
| | | 14 | — | — | — | — | — | — | — | — | — | — | — |
| | | 15 | — | — | — | — | — | — | — | — | — | — | — |
| | | 16 | — | — | — | — | — | — | — | — | — | — | — |
| | Comparative | 17 | — | — | — | — | — | — | — | — | — | — | — |
| | Examples | 18 | — | — | — | — | — | — | — | — | — | — | — |
| | | 19 | — | — | — | — | — | — | — | — | — | — | — |

As shown in Tables 9 to 11, when printing was performed by combining the aqueous liquid compositions 1 to 5 and the aqueous ink composition sets 11 to 16 that have compositions usable in the printing method according to an embodiment of the invention, printed materials having less concentration unevenness were obtained. When passing through preferable conditions (heating temperature and the like) in the drying process, printed materials with much less concentration unevenness were obtained. With respect to the aqueous ink composition set 12, the aqueous ink composition set 14, and the aqueous ink composition set 16 to which polymer particles and wax particles that can be preferably used in the aqueous ink composition were added, the concentration unevenness of the printed materials using the same further decreased. In contrast, in the case of using the aqueous liquid compositions 6 to 10 of Comparative Examples (having unsuitable compositions for use in the printing method according to an embodiment of the invention) as the aqueous liquid composition, printed materials having a high degree of concentration unevenness were obtained even when passing through the drying process. In the case of the aqueous ink composition sets 17 to 19 of Comparative Examples (having unsuitable compositions for use in the printing method according to an embodiment of the invention), unclear printed materials having a higher degree of concentration unevenness were obtained.

When air having a temperature of 100° C. was applied to the printed surface of the recording media as the drying process, all the media of the “cold laminate film PG-50L”, “cold laminate film PPM-25”, and “L round OPP60W.PA-T1E.8K” were distorted and deformed due to heat. When air having a temperature of 80° C. was applied to the printed surface of the recording media as the drying process, only the “L round OPP60W.PA-T1E.8K” was distorted and deformed due to heat. The media that were distorted and deformed due to heat were not able to evaluate the concentration unevenness. Therefore, in Tables 6 to 8, the results of the hot air setting of “100° C.” were not shown and the results of the hot air setting of “80° C.” of Table 11 were indicated as “−”.

### 3.3 Storage Stability of Aqueous Liquid Composition and Aqueous Ink Composition

The aqueous liquid compositions 1 to 10 and the aqueous ink composition sets 11 to 19 shown in Table 2 each were sealed in a sample bottle, and the sample bottles were allowed to stand for 2 weeks under a 60° C. environment. The storage stability of the aqueous ink compositions and the aqueous liquid compositions was evaluated by observing the viscosity change before and after they were allowed to stand and the separation, precipitation, and condensation states of the components. The evaluation results are shown in Table 12. The evaluation criteria are as follows.

### Viscosity Change

A: The change degree is lower than ±5% comparing with the viscosity immediately after preparation.
B: The change degree is ±5% or more and lower than ±10% comparing with the viscosity immediately after preparation.
C: The change degree is ±10% or more and lower than ±20% comparing with the viscosity immediately after preparation.
D: The change degree is ±20% or more comparing with the viscosity immediately after preparation.
   Separation, precipitation, and condensation of components
A: No separation, precipitation, and condensation of the components occurred.
B: Any one of separation, precipitation, and condensation of the components was slightly observed.
C: Any one of separation, precipitation, and condensation of the components was clearly observed.
D: Any one of separation, precipitation, and condensation of the components was noticeably observed.

Since the storage stability evaluation results of the aqueous ink composition sets shown in Table 12 were not different between colors in the same ink sets, the results were collectively shown as the ink set results.

TABLE 12

| | Aqueous liquid composition | | | | | | | | | | Aqueous ink composition set | | | | | | | | |
|---|---|---|---|---|---|---|---|---|---|---|---|---|---|---|---|---|---|---|---|
| | | | | | | Comparative | | | | | | | | | | | Comparative | | |
| | Examples | | | | | Examples | | | | | Examples | | | | | | Examples | | |
| Storage stability | 1 | 2 | 3 | 4 | 5 | 6 | 7 | 8 | 9 | 10 | 11 | 12 | 13 | 14 | 15 | 16 | 17 | 18 | 19 |
| Viscosity change | A | A | A | A | B | A | C | A | B | D | B | A | B | A | B | B | B | B | C |
| Separation, precipitation, and | A | A | A | A | A | A | D | A | A | D | B | A | A | A | B | B | B | C | D |
| condensation of components | | | | | | | | | | | | | | | | | | | |

As shown in Table 12, with the aqueous liquid compositions 1 to 5 and the aqueous ink composition sets 11 to 16 that have compositions usable in the printing method according to an embodiment of the invention, there were no problems in the viscosity change and the separation, precipitation, and condensation of the components and the storage stability was excellent comparing therewith, in the aqueous liquid compositions 6 to 10 and the aqueous ink composition sets 17 to 19 of Comparative Examples (having unsuitable compositions for use in the printing method according to an embodiment of the invention), any one of the viscosity change and the separation, precipitation, and condensation of the components or all of them were poor in some cases.

The invention is not limited to the above-described embodiments, and can be modified in various manners. For example, the invention includes the substantially same structure (e.g., structure with seine function(s), method(s), and result(s) or structure with the same object(s) and effect(s)) as the structure's described with the embodiments. The invention also includes a structure in which non-essential portions of the structures described in the embodiments are replaced. The invention also includes a structure that can demonstrate the same effects or a structure that can achieve the same objects as those in the structures described with the embodiment. The invention also includes a structure in which known techniques are added to the structures described in the embodiments.

What is claimed is:

1. A printing method for forming an image on a non-ink absorbing or low-ink absorbing recording medium using an ink jet recording method, the method comprising:
a first printing process for performing printing with an aqueous ink composition containing a colorant on a recording medium;
a second printing process for printing an aqueous liquid composition that does not contain a colorant and at least contains polymer particles in such a manner as to cover the printed image printed with the aqueous ink composition; and
a drying process for drying the printed image printed on the recording medium at a timing of at least any one of during the first printing process, after the first printing process, during the second printing process, and after the second printing process,
the aqueous ink composition at least containing a water insoluble colorant, glycol ethers having an HLB value calculated by the Davis method in the range of 4.2 to 8.0, 1,2-alkyldiols having 4 to 8 carbon atoms, and water; and
the aqueous liquid composition at least containing glycol ethers having an HLB value calculated by the Davis method in the range of 4.2 to 8.0, 1,2-alkyldiols having 4 to 8 carbon atoms, polymer particles, wax particles, and water.

2. The printing method using ink jet recording according to claim 1, wherein an alkyl group of the glycol ethers have a branched structure in each of the aqueous ink composition and the aqueous liquid composition.

3. The printing method using ink jet recording according to claim 1, wherein the glycol ethers contained in the aqueous ink composition are contained in the range of 0.1% by mass to 6% by mass based on the total amount of the aqueous ink composition and the glycol ethers contained in the aqueous liquid composition are contained in the range of 0.1% by mass to 5% by mass based on the total amount of the aqueous liquid composition.

4. The printing method using ink jet recording according to claim 1, wherein the 1,2-alkyldiols are contained 0.5 time to 5 times the glycol ethers in terms of mass ratio in each of the aqueous ink composition and the aqueous liquid composition.

5. The printing method using ink jet recording according to claim 1, wherein the alkyl group of the glycol ethers is a 2-ethylhexyl group in each of the aqueous ink composition and the aqueous liquid composition.

6. The printing method using ink jet recording according to claim 1, wherein the 1,2-alkyldiols contained in the aqueous ink composition are contained in the range of 0.5% by mass to 20% by mass based on the total amount of the aqueous ink comoosition and the 1,2-alkyldiols contained in the aqueous liquid composition are contained in the range of 0.5% by mass to 20% by mass based on the total amount of the aqueous liquid composition.

7. The printing method using ink jet recording according to claim 1, wherein the aqueous ink composition and the liquid composition further contain a pyrrolidone derivative.

8. The printing method using ink jet recording according to claim 1, wherein the aqueous ink composition and the liquid composition further contain a pyrrolidone resin derivative.

9. The printing method using ink jet recording according to claim 1, wherein the aqueous ink composition further contains polymer particles.

10. The printing method using ink jet recording according to claim 1, wherein the drying process is a drying process including heat treatment and the heating temperature after printing is higher than the heating temperature during printing in each of the first printing process and the second printing process.
